(19) United States
(12) Patent Application Publication
(10) Pub. No.: US 2024/0262709 A1
(43) Pub. Date: Aug. 8, 2024

(54) SUBSTITUTED LITHIUM-RICH CATHODE MATERIALS

(71) Applicant: Stratus Materials Inc., Pittsburgh, PA (US)

(72) Inventors: Jay F. Whitacre, Pittsburgh, PA (US); Jared Mitchell, Pittsburgh, PA (US); Adarsh Rajesh Dave, Pitttsburgh, PA (US)

(73) Assignee: Stratus Materials Inc., Pittsburgh, PA (US)

(21) Appl. No.: 18/429,308

(22) Filed: Jan. 31, 2024

Related U.S. Application Data
(60) Provisional application No. 63/596,222, filed on Nov. 3, 2023.
(60) Provisional application No. 63/482,654, filed on Feb. 1, 2023.

(51) Int. Cl. C01G 53/00; H01M 4/02; H01M 4/505; H01M 4/525; H01M 10/0525

(52) U.S. Cl. CPC C01G 53/50; H01M 4/505; H01M 4/525; H01M 10/0525; C01P 2002/01; C01P 2002/72; C01P 2004/04; C01P 2006/40; H01M 2004/028

(57) ABSTRACT

According to various embodiments, a method of quickly and inexpensively forming a crystallographically-stable, highly durable, cobalt-free, lithium-substituted, lithium-rich metal oxide (S-LRMO) material is provided, where the element that is used to replace lithium is some combination of Na, K, Ca, and Mg, and is above the levels commonly thought of as doping. In some embodiments, a cathode active material comprising a lithium-substituted, lithium-rich metal oxide is provided. For example, in some embodiments, the cathode active material comprises a chemical formula Li[LixAyMz]Ob, where A comprises at least one of Na, K, Ca and/or Mg. In some embodiments, (x+y) is greater than 0 and less than 0.3, y>0.05, z=1−(x+y), M includes Mn and Ni, and b is greater than or equal to 1.8 and less than or equal to 2.2.

### RELATED APPLICATIONS

This application claims priority under 35 U.S.C. § 119(e) to U.S. Provisional Patent Application No. 63/482,654, filed Feb. 1, 2023, and entitled “Substituted Lithium-Rich Cathode Materials,” and to U.S. Provisional Patent Application No. 63/596,222, filed Nov. 3, 2023, and entitled “Substituted Lithium-Rich Cathode Materials,” each of which is incorporated herein by reference in its entirety for all purposes.

### TECHNICAL FIELD

Electrode materials containing lithium and related synthetic methods are generally described.

### BACKGROUND

Aspects of the present invention relate to substituted lithium-rich lithium nickel manganese oxide cathode active materials, and methods of making the same. In particular, various embodiments related to the active materials in which a portion of the lithium is substituted with one or more alkali and/or alkaline earth elements.

Cobalt containing cathode material in lithium-ion batteries accounts for substantial fraction of the cost of a contemporary battery cell, and the cobalt is a key contributor to the cost. Cobalt has supply chain complexities that make it a volatile commodity. As such, there is a need for reliable cobalt-free lithium-ion battery cathode materials. Likewise, the cost of lithium has increased significantly in recent years. As such, reducing the lithium content of cathode materials while maintaining electrochemical performance is of extreme interest. Accordingly, improved materials and methods are needed.

### SUMMARY

The subject matter of the present invention involves, in some cases, interrelated products, alternative solutions to a particular problem, and/or a plurality of different uses of one or more systems and/or articles.

According to various embodiments, a method comprises sintering a substituted lithium-rich metal oxide (S-LRMO) material at a sintering temperature to form a sintered S-LRMO material; and quenching the sintered S-LRMO material from the sintering temperature to room temperature in less than 500 milliseconds to form an S-LRMO active material represented by the formula Li[LiₓA_{y}M_{z}]O_{b}, wherein A comprises at least one of Na, K, Ca or Mg, (x+y) is greater than 0 and less than 0.3, y>0.05, z=1−(x+y), M comprises Mn and Ni, and b ranges from 1.8 to 2.2. In some embodiments, during and/or following synthesis of the S-LRMO material, at least a portion of the S-LRMO has a “lithium-rich transition metal oxide”-type crystal structure, though the S-LRMO material may comprise other elements substituted for lithium.

According to various embodiments, a method comprises thermally decomposing a precursor material using convection heating, microwave radiation (e.g., direct microwave radiation), and/or radiative heating to form a thermally decomposed substituted lithium-rich metal oxide (S-LRMO) material; sintering the thermally decomposed S-LRMO material to form a sintered S-LRMO material; and quenching the sintered S-LRMO material to form a quenched S-LRMO material represented by a chemical formula Li[LiₓA_{y}M_{z}]O_{b}, wherein A comprises at least one of Na, K, Ca or Mg, (x+y) is greater than 0 and less than 0.3, y>0.05, z=1−(x+y), M comprises Mn and Ni, and b ranges from 1.8 to 2.2.

According to various embodiments, a cathode active material is represented by a chemical formula Li[LiₓA_{y}M_{z}]O_{b}, in which A is at least one of Na, K, Ca or Mg, (x+y) is greater than 0 and less than 0.3, y>0.05, z=1−(x+y), M includes Mn and Ni, and b ranges from 1.8 to 2.2.

Other advantages and novel features of the present invention will become apparent from the following detailed description of various non-limiting embodiments of the invention when considered in conjunction with the accompanying figures. In cases where the present specification and a document incorporated by reference include conflicting and/or inconsistent disclosure, the present specification shall control.

### BRIEF DESCRIPTION OF THE DRAWINGS

Non-limiting embodiments of the present invention will be described by way of example with reference to the accompanying figures, which are schematic and are not intended to be drawn to scale. In the figures, each identical or nearly identical component illustrated is typically represented by a single numeral. For purposes of clarity, not every component is labeled in every figure, nor is every component of each embodiment of the invention shown where illustration is not necessary to allow those of ordinary skill in the art to understand the invention. In the figures:

The accompanying drawings, which are incorporated herein and constitute part of this specification, illustrate example embodiments of the invention, and together with the general description given above and the detailed description given below, serve to explain the features of the invention.

FIG. 1 is a photograph of a rapid quenching system, according to various embodiments of the present disclosure.

FIG. 2 includes four sequential video capture time-laps images filmed at 30 frames per second, showing a rapid quenching process, according to various embodiments of the present disclosure.

FIGS. 3 and 4 are graphs showing X-ray diffraction (XRD) patterns for Liₓ(Mn_{y}Ni_{1-y})₂₋ₓO₂ materials, where x=1.2, and y=0.75 before and after rapid quenching respectively, according to various embodiments of the present disclosure.

FIG. 5 is a graph showing X-ray diffraction pattern for a Liₓ(Mn_{y}Ni_{1-y})₂₋ₓO₂ material, where x=1.16, and y=0.7

FIG. 6 is a graph illustrating X-ray diffraction pattern for a Liₓ(Mn_{y}Ni_{1-y})₂₋ₓO₂ material, where x=1.16, and y=0.7, that was processed using microwave heating and ultra-rapid quenching, according to various embodiments of the present disclosure.

FIG. 7A is a transmission electron microscopy (TEM) atomic map micrograph of a prior art LRMO material that was not subjected to rapid quenching prior to electrochemically cycling the material.

FIG. 7B is a TEM HAADF atomic map micrograph of non-substituted LRMO material that was subjected to rapid quenching prior to electrochemically cycling the material, according to various embodiments of the present disclosure.

FIG. 8A is a graph showing cell potential vs. specific capacity, and FIG. 8B is a graph of the specific capacity vs cycle for a comparative example of a Liₓ(Mn_{y}Ni_{1-y})₂₋ₓO₂ material, where x=1.16, and y=0.7, that was neither microwave processed nor rapid quenched (in this case cooled relatively slowly on a metal plate).

FIG. 9A is a graph showing cell potential vs. specific capacity during break-in cycles, FIG. 9B is a graph showing cell potential vs specific capacity over time, FIG. 9C is a graph showing specific capacity vs cycle at C/20 rate, and FIG. 9D is a graph showing discharge specific capacity at C/5 rate with C/20 reference cycles vs cycle number for exemplary cells including LRMO active materials according to comparative embodiments of the present disclosure.

FIG. 10 is a chart showing X-ray diffraction pattern results for an S-LRMO active material having the formula: Li[Li_{0.14} Na_{0.06}Mn_{0.6}Ni_{0.2}]O₂, according to various embodiments of the present disclosure.

FIG. 11 is a chart showing X-ray diffraction pattern results for an S-LRMO active material having the formula: Li[Li_{0.06}Na_{0.14}Mn_{0.6}Ni_{0.2}]O₂, according to various embodiments of the present disclosure.

FIG. 12 is a chart showing X-ray diffraction pattern results for an S-LRMO active material having the formula: Li[Li_{0.06}K_{0.14} Mn_{0.6}Ni_{0.2}]O₂, according to various embodiments of the present disclosure.

FIG. 13 is a chart showing X-ray diffraction pattern results for an S-LRMO active material having the formula: Li[Li_{0.06} Na_{0.07}K_{0.07} Mn_{0.6}Ni_{0.2}]O₂, according to various embodiments of the present disclosure.

FIG. 14 is a transmission electron micrograph and EDS elemental map of an S-LRMO material having the formula: Li[Li_{0.14} Na_{0.06}Mn_{0.6}Ni_{0.2}]O₂, showing equal distribution of Mn and Ni throughout the material.

FIG. 15 is a chart showing electrochemical data including charge/discharge performance for an S-LRMO material, according to various embodiments of the present disclosure.

FIG. 16 is a chart showing electrochemical data including charge/discharge performance for an S-LRMO material, according to various embodiments of the present disclosure.

FIG. 17 is a chart showing electrochemical data including cycle life for an S-LRMO material, according to various embodiments of the present disclosure.

FIG. 18 is a chart showing electrochemical data including charge/discharge performance for an S-LRMO material, according to various embodiments of the present disclosure.

FIG. 19 is a chart showing electrochemical data including efficiency as a function of cycle number for an S-LRMO material, according to various embodiments of the present disclosure.

FIGS. 20A-20B are charts showing electrochemical data including cycle life for an S-LRMO material, according to various embodiments of the present disclosure.

FIG. 21 is a chart showing electrochemical data including charge/discharge performance for an S-LRMO material, according to various embodiments of the present disclosure.

FIG. 22 is a chart showing electrochemical data including charge/discharge performance for an S-LRMO material, according to various embodiments of the present disclosure.

FIG. 23 is a chart including rate capability data of a potassium substituted LRMO material, according to various embodiments of the present disclosure.

FIG. 24 is a chart showing data for the first two charge/discharge cycles for a lithium metal half-cell made using the material: Li[Li_{0.015} Na_{0.155} Mn_{0.58}Ni_{0.25}]O₂, which shows specific capacity of over 250 mAh/g at C/20 rate, according to various embodiments of the present disclosure.

FIG. 25 is a chart showing cycle life data from a lithium metal anode half-cell made of the material: Li[Li_{0.015} Na_{0.155} Mn_{0.58}Ni_{0.25}]O₂, which shows stable capacity retention and repeated reference cycles well over 200 mAh/g. The median discharge voltage is also nominally stable, which is not typical for lithium rich cathode materials, according to various embodiments of the present disclosure.

FIGS. 26A-26B are charts showing GITT (galvanostatic intermittent titration) derived diffusivity data showing that the lithium-ion transport of Li[Li_{0.015}Na_{0.155}Mn_{0.58}Ni_{0.25}]O₂ prepared as described is superior in at least some aspects to that of Li[Li_{0.16}Mn_{0.58}Ni_{0.25}]O₂ material at lower states of charge, according to one set of embodiments.

FIGS. 27A and 27B are charts showing GITT (galvanostatic intermittent titration) derived diffusivity data (FIG. 27A) showing that the lithium-ion transport of Li_{1.081}Na_{0.057} Mn_{0.652}Ni_{0.21}O₂ prepared as described is superior in at least some aspects to that of Li_{1.17}Mn_{0.58}Ni_{0.25} O₂ material at lower states of charge, according to one set of embodiments, and fast pulse resistance (FIG. 27B) of identical test cells (14 mm diameter circular electrodes) using Li_{1.081} Na_{0.057}Mn_{0.652}Ni_{0.21}O₂ as compared to Li_{1.17}Mn_{0.58}Ni_{0.25}O₂.

FIGS. 28A-28C are plots showing long term (320 cycles) cycle stability of sodium substituted S-LRMO material (Li_{1.081}Na_{0.057} Mn_{0.652}Ni_{0.21}O₂): FIG. 28A capacity stability (C/3 daily cycles with C/15 reference cycles every 25); FIG. 28B: average discharge voltage; and FIG. 28C coulombic efficiency.

### DETAILED DESCRIPTION

According to various embodiments, a method of quickly and inexpensively forming a crystallographically-stable, highly durable, cobalt-free, lithium-substituted, lithium-rich metal oxide (S-LRMO) material is provided, where the element that is used to replace lithium is some combination of Na, K, Ca, and Mg, and is above the levels commonly thought of as doping. In some embodiments, a cathode active material comprising a lithium-substituted, lithium-rich metal oxide is provided. For example, in some embodiments, the cathode active material comprises a chemical formula Li[LiₓA_{y}M_{z}]O_{b}, where A comprises at least one of Na, K, Ca or Mg. Such methods and materials are described in more detail, below.

It has been realized in the context of this disclosure that, for at least some lithium-containing cathode materials, finding materials that can substitute for lithium in the material without having a substantial deleterious effect on the material's properties (e.g., without substantially changing the crystalline structure or performance of the material) is of interest.

### LRMO Materials

The following section describes techniques for preparing non-substituted LRMO materials. The non-substituted LRMO materials may provide insight with respect to the substituted LRMO materials (S-LRMO materials) described in detail below. It has been observed in the context of this disclosure that in some embodiments, the techniques and conditions described for the non-substituted LRMO materials described below can be employed for the preparation of S-LRMO materials (e.g., with the resulting S-LRMO showing advantageous and desirable crystallographic/structural and electrochemical performance properties).

In some embodiments, non-substituted LRMO materials (e.g., LRMO materials that do not include alkali or alkaline earth metals substituted for Li) may be represented by the following general Formula 1:

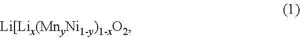

wherein x is greater than or equal to 0 and less than or equal to 0.3, and y is less than or equal to 0.95 and greater than or equal to 0.1, for example less than or equal to 0.8 and greater than or equal to 0.5.

In some embodiments, the non-substituted LRMO material is a lithium-rich, lithium manganese nickel oxide material represented by the following Formula 2:

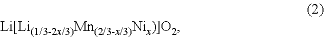

wherein x is greater than or equal to 0.1 and less than or equal to 0.4.

The non-substituted LRMO material in its pristine state (e.g., before it is charged for the first time), may have, in some embodiments, distinct hexagonal (e.g., rhombohedral) and monoclinic phases. Thus, in some embodiments, the LRMO material may be represented by the expression: (1−x)[Li₂MnO₃]*x[LiMnₐNi(₁₋ₐ)O₂], wherein the first part of this expression denotes the relative molar amount of the monoclinic phase (1−x), while the second part of this expression denotes the relative molar amount of the rhombohedral phase (x). In some embodiments, the molar fraction of the rhombohedral phase, “x”, commonly ranges between 0.8 and 0.95, while “a” is greater than or equal to 0.6 and less than or equal to 0.9. In some embodiments, the two phases may be disposed in a layered structure.

Various embodiments may provide non-substituted LRMO materials that exhibit high (e.g., >240 mAh/g) specific capacities and high functional voltage windows (e.g., greater than or equal to 2.0 and less than or equal to 4.8 V), when used as an active material of a cobalt-free cathode.

According to various embodiments, methods of forming non-substituted LRMO materials include rapid thermal processing and rapid (e.g., less than 10 seconds) or ultra-rapid (e.g., less than or equal to 500 milliseconds) quenching that result in a LRMO material having a superior crystal structure with a desired atomic order/disorder. These features may provide unexpectedly robust long-term stability and performance when used as a cathode active material.

Certain non-substituted LRMO materials (e.g., synthesized without rapid quenching and/or quenching in water) may be unsuitable for use as a cathode active material due to having a low-rate capability and/or poor capacity retention, which are believed to result from, for example, structural instability due to oxygen losses, transition metal ion migration during use, and/or possible manganese dissolution. Without wishing to be bound by theory, the two most common aging mechanisms manifest as a fade in the average discharge voltage as the material slowly re-organizes into a predominant spinel structure, and loss in capacity over cycling due mechanical and/or chemical degradation of the material.

### Thermal Decomposition and Processing of Non-Substituted LRMO Materials

LRMO materials, including substituted and non-substituted LRMO materials, may be synthesized from precursor materials by a variety of methods. The following Table 1 includes particular methods that may be used to synthesize LRMO materials, including precursor synthesis, precursor materials, quenching methods, performance metrics, and discharge capacity (DC) of LRMO material cathodes.

TABLE 1

| Source # | Route | Precursors | Quench | x= | 3rd DC (mAh/g) |
|---|---|---|---|---|---|
| 4 | Sol-gel then | Acetates and | Metallic | 0.50 | 170 |
| | combustion | Nitrates | | 0.33 | 225 |
| | | | | 0.25 | 230 |
| | | | | 0.17 | 235 |
| 5 | Precipitation | Nitrates and | Slow Cooling | 0.33 | 128 |
| | then combustion | Hydroxides | | 0.42 | 138 |
| | | | | 0.50 | 155 |
| | | | Metallic | 0.33 | 135 |
| | | | | 0.42 | 150 |
| | | | | 0.50 | 145 |
| | | | | 0.17 | 225 |
| | | | | 0.25 | 255 |
| | | | | 0.33 | 250 |
| | | | | 0.42 | 235 |
| | | | | 0.50 | 200 |
| 7 | Hydrothermal | Acetates, Nitrates, | none | 0.10 | 200 |
| | | and Hydroxides | | | |
| 9 | Precipitation | Nitrates and | LN2 | 0.33 | 190 |
| | then combustion | Hydroxides | | 0.33 | 110 |
| 10 | Precipitation | Nitrates and | LN2 | 0.50 | |
| | then combustion | Hydroxides | | | |
| 11 | Precipitation | Nitrates and | Slow Cooling | 0.20 | |
| | then combustion | Hydroxides | | | |
| 12 | Sol-gel then | Nitrates and Glycine | LN2 | 0.50 | |
| | combustion | | | 0.40 | |
| 13 | Sol-gel then | Acetates and misc | No mention | 0.20 | |
| | combustion | | | | |
| 21 | Precipitation | Chlorides and | LN2 | 0.25 | 220 |
| | then combustion | Hydroxides | | 0.25 | 260 |
| | | | | 0.25 | 215 |
| | | | | 0.25 | 260 |
| 22 | Sol-gel then | Acetates and Misc | no mention | 0.2 | 210 |
| | combustion | | | 0.2 | 215 |
| 26 | Precipitation | Hydroxides | LN2 | 0.33 | |
| | then combustion | | | | |
| 28 | Precipitation | Sulfates and | No mention | 0.20 | |
| | then combustion | Carboantes | | | |
| 29 | Precipitation | Sulfates, | No mention | 0.23 | 180 |
| | then combustion | Carboantes, and | | | |
| | | Misc | | | |
| 30 | Precipitation | Sulfates, and misc | No mention | 0.2 | 215 |
| | Sol-Gel | Acetates | No mention | | 215 |
| | Hydrothermal | Acetates and PVP | Na | | 225 |

As shown in Table 1, the three main synthetic routes for LRMO materials include precipitation followed by combustion, hydrothermal synthesis, and sol-gel solution production followed by intermediate temperature decomposition and high temperature thermal processing (e.g., calcination, annealing, sintering).

As can be seen in Table 1, the number of investigations exploring the effects of nickel composition on the performance LRMO cathodes has decreased over time; with few studies exploring multiple nickel compositions or nickel compositions below x=0.2 in cathodes having the formula Li[NiₓLi(_{1/3-2x/3})Mn(_{2/3-x/3})]O₂. Table 1 also shows that there are significant inconsistencies in synthetic routes employed across studies. Additionally, there are few studies that perform a detailed comparative assessment relating the effects of synthetic approach to performance of LRMO cathodes. In LRMO materials, the ordering and disordering of transition metals may be important, and both composition and synthetic techniques may provide mechanisms for influencing the degree of structural order and disorder. The electrochemical behaviors these compositional and synthetic changes could impose, such as different defect concentrations for example, may lead to pronounced effects on the properties of LRMO cathodes.

Without wishing to be bound by a particular theory, it is believed that when a sample is quenched in liquid nitrogen, the particles are immediately shielded by an insulating envelope of nitrogen gas, similar to the Leidenfrost effect, which significantly reduces heat transfer rate. It is believed that in preparation of certain traditional cathode materials, lithium-containing cathode materials for lithium ion batteries are not brought in contact with moisture because water leaches out lithium from such cathode materials and forms a lithium hydroxide coating on the materials. Furthermore, water is known to cause malfunctions in lithium ion batteries, such as lithium-ion batteries which contain lithium iron phosphate cathode materials.

While not wishing to be bound to a particular theory, the present inventors believe that the relatively slow conventional quenching and cooling process result in agglomeration of metal oxides, thereby forming segregated nickel oxide and lithium manganese oxide phases. In particular, the nickel oxide phase may be concentrated on the surface of LRMO material particles (e.g., crystallites). Without wishing to be bound by theory, this surface nickel oxide agglomeration, and in general nickel and manganese segregation in the crystal structure may be at least partially responsible for the chemical instability of conventional LRMO active materials.

In contrast, the present inventors have unexpectedly determined that water quenching does not negatively affect the LRMO cathodes and does not cause lithium leaching from such LRMO cathodes. Examples of embodiments in which water quenching is performed with non-substituted LRMOs are described in U.S. Patent Application Publication No. 2023/0015455, published on Jan. 19, 2023, filed as U.S. patent application Ser. No. 17/810,722 on Jul. 5, 2022, and entitled “Lithium-Rich Nickel Manganese Oxide Battery Cathode Materials and Methods,” which is incorporated herein by reference in its entirety for all purposes. It is believed that water quenching results in vaporization in the form of bubble nucleation and dissipation, which actually increases the rate of heat transfer. As such, it is believed that water quenching should have a rate of heat transfer that can be approximated as two orders of magnitude greater than liquid nitrogen quenching. Further, water and additives solvated into it (i.e., other materials that may be dissolved in the water) can both react with the high temperature LRMO as it quenches and after quenching to create advantageous surface terminations and/or coatings that enhance electrochemical stability and durability when used in a lithium-ion battery. As described in more detail below, the methods, conditions, parameters, and/or processing steps described above may, in some embodiments, be applied to the substituted LRMO materials described in this disclosure.

Additionally, in many of the prior art quench routes described above in the context of Table 1, the quenching is done on pressed sintered or partially sintered pellets of the material that are intact as larger bodies (e.g., having a width on the order of centimeters). In contrast, in some embodiments of the present disclosure, the quenching is performed on loose and/or milled powder with particles that are in shapes and/or agglomerates that are 20 microns or less in average diameter, such as greater than or equal to 0.1 and less than or equal to 20 microns, for example, greater than or equal to 0.1 and less than or equal to 1 microns or greater than or equal to 1 and less than or equal to 20 microns, in average diameter, such that when the particles contact the quenching liquid (e.g., water) all of the material cools rapidly and at approximately the same rate. Other ranges are also possible. Each agglomerate may be composed of crystallites having an average size of greater than or equal to 25 nm to and less than or equal 500 nm, such as greater than or equal to 50 nm and less than or equal to 200 nm. Other ranges are also possible. Each crystallite may comprise a single crystal of the LRMO material. The crystallites may be partially fused together in the agglomerate or fully fused together in the agglomerate. If the crystallites are fully fused in the agglomerate (i.e., in a powder particle), then each crystallite may comprise a single crystal grain of the powder particle which is separated from other single crystal grains in the same powder particle by grain boundaries. The average crystal grain size of the powder particles may be greater than or equal to 25 nm and less than or equal to 500 nm, such as greater than or equal to 50 nm and less than or equal to 200 nm. Other ranges are also possible. The agglomerates may be relatively porous, which allows the water to reach the crystallites inside the agglomerate.

In some embodiments, the material subjected to the quenching (e.g., an LRMO or an S-LRMO, described below) comprises a powder comprising particles (e.g., loose particles) having an average largest cross-sectional dimension of less than or equal to 20 microns, less than or equal to 10 microns, less or equal to 5 microns, less than or equal 2 microns, or less. In some embodiments, the material subjected to the quenching (e.g., an LRMO or an S-LRMO, described below) comprises a powder comprising particles (e.g., loose particles) having an average largest cross-sectional dimension greater than or equal to 0.1 microns, greater than or equal to 0.2 microns, greater than or equal to 0.5 microns, greater than or equal to 1 micron, or greater. Combinations of these ranges are possible, as noted above. Other ranges are also possible. In some embodiments, the material subjected to the quenching (e.g., an LRMO or an S-LRMO, described below) comprises a powder comprising particles (e.g., loose particles) comprising agglomerates of crystallites having an average largest cross-sectional dimension of greater than or equal to 25 nm, greater than or equal to 50 nm, greater than or equal to 100 nm or greater. In some embodiments, the material subjected to the quenching (e.g., an LRMO or an S-LRMO, described below) comprises a powder comprising particles (e.g., loose particles) comprising agglomerates of crystallites having an average largest cross-sectional dimension of less than or equal to 500 nm, less than or equal to 300 nm, less than or equal to 200 nm, or less. Combinations of these ranges are possible. Other ranges are also possible. The average largest cross-sectional dimensions of the particles and/or crystals may be determined by, for example transmission electron microscopy

### Rapid and Ultra-Rapid Quenching of LRMO Materials

According to various embodiments, a LRMO cathode active material may be formed by thermally processing (e.g., sintering, calcining, and/or annealing) and quenching the LRMO material powder. In particular, the thermal processing may include a high-temperature process where the LRMO material may be heated to a process temperature of greater than or equal to 800° C. and less than or equal to 1000° C., such as greater than or equal to 850° C. and less than or equal to 950° C., or 900° C. Other ranges are also possible. The thermal processing may be carried out in any suitable thermal processing apparatus, such as a furnace, for example a tube furnace, muffle box furnace, rotary hearth kiln, belt furnace etc. In some embodiments, the thermal processing may optionally include one or more low-temperature precursor decomposition (e.g., firing) processes where the LRMO material is heated to a temperature above room temperature and below 800° C. For example, the firing may include heating the LRMO material to a temperature of greater than or equal to 450° C. and less than or equal to 550° C., such as 500° C., prior to the high-temperature process. Other ranges are also possible.

According to various embodiments, the quenching process may include transferring the heated LRMO material to a quench bath. For example, the LRMO material may be dropped directly into from the thermal processing apparatus into the quench bath. As described in more detail below, the methods, conditions, parameters, and/or processing steps described above may, in some embodiments, be applied to the substituted LRMO materials described in this disclosure.

In prior art methods, the LRMO material may slowly cool during transfer from the furnace. For example, the transfer process may take up to 10 seconds, during which the temperature of the LRMO material may be slowly reduced. The present inventors have determined that slow cooling prior to entering the quench bath may result in undesirable changes to the crystal structure of the sintered LRMO material. In other words, the temperature at which the sintered LRMO material enters the quench bath may be important to providing a desired crystal structure. For example, slow cooling may result in a less desirable crystal structure.

According to various embodiments, the transfer process may be configured such that the sintered LRMO material enters the quench bath after a sintering process at a temperature of at least 800° C., such as a temperature of greater than or equal to 800° C. and less than or equal to 950° C., or greater than or equal to 850° C. and less than or equal to 925° C., or 900° C. For example, the transfer time from the thermal processing apparatus to the quench bath may be limited to 10 seconds or less, such as 1 seconds or less, such as less than 0.5 seconds, or 0.2 seconds or less. Thus, the sintered LRMO material is cooled from the thermal processing temperature (e.g., from the sintering temperature of at least 800° C., such as a temperature of greater than or equal to 800° C. and less than or equal to 950° C., or greater than or equal to 850° C. and less than or equal to 925° C., or 900° C.) to room temperature (e.g., 25° C.) in 10 seconds or less, such as less than 0.5 seconds, including 0.2 seconds or less. Other ranges are also possible. Herein, an “ultra-rapid quenching process” may have a cooling time of less than 0.5 seconds, such as 0.2 seconds or less, for example greater than or equal to 0.1 and less than or equal to 0.2 seconds, and a “rapid quenching process” may have a cooling time of 10 seconds or less, such as greater than or equal to 0.5 seconds and less than or equal to 10 seconds. Other ranges are also possible.

The sintered LRMO powder particles may be quenched in the quench bath at an average rate of at least 50° C./second, such as at least 50° C./second and less than or equal to 10,000° C./second. For example, the sintered LRMO powder particles may be quenched at a rate of greater than or equal to 87.5° C./second and less than or equal to 8750° C./second, such as greater than or equal 1750° C./second, for example greater than or equal to 1750° C./second and less than or equal to 8750° C./second, including greater than or equal to 4375° C./second and less than or equal to 8750° C./second. Other ranges are also possible. Thus, the sintered LRMO material may be quenched from a temperature between the thermal processing temperature (e.g., sintering temperature) of at least 800° C. to the temperature of the quench bath (e.g., room temperature water bath at 25° C.) in 10 seconds or less, such as in less than 500 milliseconds, including 400 milliseconds or less, 300 milliseconds or less, or 200 milliseconds or less. For example, the quenching may occur in a time period of and less than or equal 100 milliseconds and less than or equal to 400 milliseconds, or greater than or equal to 100 and less than or equal to 200 milliseconds. Other ranges are also possible. As described in more detail below, the methods, conditions, parameters, and/or processing steps described above may, in some embodiments, be applied to the substituted LRMO materials described in this disclosure.

The quench bath may comprise a high heat capacity liquid solvent having a vaporization temperature of below 200° C. For example, the quench bath may comprise a solvent, such as water, an oil, and/or an alcohol. In some embodiments, the quench bath may comprise additives configured to modify the surface of the LRMO material during quenching to improve long term chemical stability of the material. The additive may comprise an acid, a base, an alcohol and/or a dissolved carbon species, such as the acid, the alcohol or the carbon species dissolved in water.

For example, the quench bath may be an aqueous quenching solution that includes greater than or equal to 0.01 and less than or equal to 1.0 moles per liter, such as greater than or equal to 0.1 and less than or equal to 1.0 moles per liter, or greater than or equal to 0.5 and less than or equal to 1.0 moles per liter, of an acid additive, such as sulfuric acid, hydrochloric acid, nitric acid, oxalic acid, citric acid, acetic acid, phosphoric acid, orthophosphoric acid, lithium hydroxide, sodium hydroxide, potassium hydroxide, combinations thereof, or the like. Other ranges are also possible. The acid may be configured to stabilize the surface of the LRMO particles by reacting with and/or passivating dangling bonds and/or OH terminal groups of the LRMO power particles that are being quenched in the water containing the acid additive.

In some embodiments, the acid quenching may result in the formation of a spinel structure (e.g., surface layer) on the surfaces the quenched LRMO powder particles. The spinel structure may form a framework that stabilizes the particles and provides three-dimensional pathways for lithium diffusion. In particular, it is believed that the acid may result in an exchange of Li ions of the particles with H ions of the acid, and a subsequent structural transformation of the surface of the particles, resulting in the formation of the spinel surface layer.

In another embodiment, the quenching solution may include an alcohol and/or a carbohydrate additive in addition to or in place of the acid additive. For example, the alcohol may include isopropyl alcohol or another alcohol, and the carbohydrate may include a sugar, such as fructose, galactose glucose, lactose, maltose, sucrose, combinations thereof, or the like. In some embodiments, the quenching solution may include greater than or equal to 0.01 and less than or equal to 1.0 moles per liter, such as greater than or equal to 0.1 and less than or equal to 1.0 mole per liter, or greater than or equal to 0.5 and less than or equal to 1.0 mole per liter, of the carbohydrate additive. Other ranges are also possible. In some embodiments, the carbohydrates may form an intimate amorphous carbon coating on the surface of the LRMO powder particles during the quenching process in water containing the carbohydrate particle. Without wishing to be bound by theory, the carbon coating may advantageously be permeable to Li ions but may be impermeable to an electrolyte of the Li-ion battery. The carbon coating may also permit volumetric changes in the LRMO crystallites to occur during charging and discharging of the battery. As described in more detail below, the methods, conditions, parameters, and/or processing steps described above may, in some embodiments, be applied to the substituted LRMO materials described in this disclosure.

The rapid or ultra-rapid quenching processes may produce a quenched LRMO material having a crystal structure that provides unexpected robustness and electrical characteristics. Specifically, the degree of crystalline order in the quenched LRMO material (e.g., lithium-rich lithium manganese nickel oxide) that is produced by the quenching processes may provide performance characteristics that are suited for use as a cathode active material of a lithium-ion battery that provides energy density and charge storage stability characteristics that are similar to that of cathodes that include cobalt-containing, high nickel-content, active materials.

The quenching processes may produce a quenched LRMO material powder having a desired crystal structure and particle size. For example, the sintered LRMO material being quenched may be a loose powder having an average particle size of 1 μm or less, such as an average particle size ranging of greater than or equal to 0.02 μm and less than or equal to 1 μm, or greater than or equal to 0.05 μm and less than or equal to 0.5 μm. Other ranges are also possible. The quenched LRMO material may include crystal phases and/or crystallites having an average crystal size of greater than or equal to 25 nm and less than or equal to 500 nm, such as greater than or equal to 50 nm and less than or equal to 300 nm, in some embodiments. Each powder particle may comprise one crystallite or more than one crystallite. The loose sintered and quenched powder particles may be incorporated into a binder (e.g., carbon binder) to form a cathode electrode for a Li-ion battery. Other ranges are also possible.

In some embodiments, the sintered and/or quenched LRMO material (or sintered and/or quenched S-LRMO material described below) comprises a loose powder comprising particles having an average largest cross-sectional dimension of less than or equal to 1 micron, less than or equal to 0.5 microns, or less. In some embodiments, the sintered and/or quenched LRMO material (or S-LRMO material described below) is a loose powder comprising particles having an average largest cross-sectional dimension of greater than or equal to 0.02 microns, greater than or equal to 0.05 microns, greater than or equal to 0.1 microns, greater than or equal to 0.2 microns, or greater. Combinations of these ranges (e.g., greater than or equal to 0.02 microns and less than or equal to 1 micron, or greater than or equal to 0.05 micron and less than or equal to 0.5 micron) are possible. Other ranges are also possible.

In some embodiments, the sintered and/or quenched LRMO material (or sintered and/or quenched S-LRMO material described below) comprises a loose powder comprising particles having crystal phase and/or crystallites having an average largest cross-sectional dimension of less than or equal to 500 nm, less than or equal to 300 nm, less than or equal to 200 nm, or less. In some embodiments, the sintered and/or quenched LRMO material (or sintered and/or quenched S-LRMO material described below) comprises a loose powder comprising particles having crystal phase and/or crystallites having an average largest cross-sectional dimension of greater than or equal to 25 nm, greater than or equal to 50 nm, greater than or equal to 100 nm, greater than or equal to 150 nm, or greater. Combinations of these ranges (e.g., greater than or equal to 25 nm and less than or equal to 500 nm, greater than or equal to 50 nm and less than or equal to 300 nm) are possible. Other ranges are also possible.

The quenched LRMO material may be dried to form a LRMO active material (e.g., the thermally processed and quenched loose powder particles), which may have a hexagonal primary phase and a monoclinic secondary phase. Thus, the ratio of the hexagonal phase content to monoclinic phase content is greater than 1, such as at least 2, for example at least 2 and less than or equal to 20, according to some embodiments. For example, the sintered and quenched LRMO material (e.g., dried active material) may have a superlattice structure including hexagonal primary phase layers separated by interlayers of the monoclinic secondary phase. Alternatively, the sintered and quenched LRMO material may include a hexagonal phase matrix containing monoclinic phase nano-zones (i.e., areas having a width of less than a micron). Mn and Ni may be homogenously distributed within the crystal structure of the LRMO material (e.g., excess Mn, Ni and Li are homogenously and uniformly distributed on the transition metal crystal lattice sites). For example, crystalline particles of the sintered and quenched LRMO material may exhibit a uniform distribution of Mn and Ni atoms throughout the crystalline particles such that there are no regions that are Ni rich or Mn rich when imaged by high-angle annular dark-field (HAADF) energy dispersive X-ray spectrometry (EDS) (i.e., in EDS elemental maps of HAADF tunneling electron microscopy images). In one embodiment, the term “no regions that are Ni rich or Mn rich” in a crystalline particle means that there are no crystalline volumes greater than 3×3×3 nm in the crystalline particle in which there is a greater than 3% difference between ratios of Ni and Mn atoms compared to average ratios of the Ni and Mn atoms in the entire crystalline particle.

The crystal structure of the as-formed active LRMO material may be changed by electrochemical cycling. For example, when the active LRMO material is included as an active material in an electrochemical cell, after a first charge/discharge cycle, the monoclinic phase may no longer be present at detectable levels. It is believed that the monoclinic phase may be consumed during Li ion insertion and/or extraction. As described in more detail below, the methods, conditions, parameters, and/or processing steps described above may, in some embodiments, be applied to the substituted LRMO materials described in this disclosure.

### Rapid Precursor Decomposition in Non-Lithium-Substituted LRMO Materials

LRMO materials may be formed from various precursor materials. For example, precursor materials may be metalloorganic compounds comprising a metal, such as Li, Mn, and/or Ni, and a solubilizing agent, such as an organic ligand. For example, precursor materials may include metal acetates, metal carbonates, metal nitrates, metal sulfates, and/or metal hydroxides.

In various embodiments, LRMO materials may be formed by thermally decomposing a precursor material followed by sintering and quenching the resulting thermally decomposed LRMO material. The precursor material may comprise a gel formed via a sol-gel process. The gel may comprise a nonfluid network of material (e.g., a colloidal network or polymer network) having a relatively small yield stress and that is expanded throughout its whole volume by a fluid (e.g., a liquid such as water). A gel may contain a network formed by covalent bonds or via other mechanisms such as physical aggregation. A sol-gel process may involve converting monomers into a colloidal solution (a sol) that can serve as a precursor for a resulting gel (e.g., of discrete particles or network polymers). The present inventors have determined that rapidly decomposing a precursor material gel may improve the homogeneity of LRMO materials. For example, in a sol part of the sol-gel process, stoichiometric amounts of Li, Mn, and Ni-containing precursors may be mixed with water to form an aqueous mixture. For example, stoichiometric amounts of Li(CH₃COO)*2H₂O, Mn(CH₃COO)₂*4H₂O, and Ni(NO₃)₂*6H₂O, may be mixed to form the aqueous mixture. However, the present disclosure is not limited to any particular precursor materials. For example, in some embodiments, all acetate precursors or all nitrate precursors (i.e., lithium, manganese and nickel nitrates) may be used. In some embodiments, the mixture may comprise a greater than or equal to 0.01 and less than or equal to 0.20 molar fractional excess of the lithium acetate precursor to compensate for lithium loss during processing. Other ranges are also possible.

The mixture may then be heated to form the precursor gel. For example, the mixture may be heated at a temperature of greater than or equal to 90° C. and less than or equal to 150° C., such as 100° C., for a time period sufficient for gelation to occur. Other ranges are also possible.

The gel may then be thermally decomposed. For example, the gel may be heated at a temperature and for a time period sufficient to extract (e.g., volatize and/or decompose) solubilizing agents, such as organic ligands and/or solvents of the gel and form a thermally decomposed LRMO material.

The thermal decomposition may be performed using a conventional furnace, such as a muffle box and/or tube furnace. However, such devices generally have slow heating and cooling rates on the order of greater than or equal to 1 and less than or equal to 10° C. per minute, and do not employ any type of direct radiation thermal energy input. As such, conventional furnaces may require at least 8 hours of processing time and a significant amount of energy to form the thermally decomposed LRMO material.

According to various embodiments, rapid (e.g., high rate) heating methods are used to form a thermally decomposed LRMO material. For example, an embodiment may utilize microwave radiation to thermally process LRMO precursor materials (i.e., to rapidly decompose LRMO precursors, such as the gel precursors formed via a sol-gel process). For example, the microwave radiation may be direct microwave radiation. Other suitable types of heating for at least some embodiments include, but are not limited to, convection heating and/or radiative heating. Combinations of heating methods may be used. For example, the thermal decomposition may involve convection heating, microwave radiation (e.g., direct microwave radiation), and/or radiative heating.

Microwaves are defined as electromagnetic radiation with wavelengths of greater than or equal to 1 mm and less than or equal to 1 m. The widely adopted domestic microwave ovens use microwave radiation with frequency around 2.45 GHz. Regulations have restricted the microwave frequencies that may be used for domestic and industrial applications. The mechanisms of microwave heating are believed to be attributed into two categories: 1) the flow of current under the external electric field generated by microwave radiation generates heat due to ohmic effect; and 2) dipoles that exist in ceramic re-orientate themselves under a changing electric field generate heat due to frictions.

Microwave heating may allow for lower thermal processing (e.g., precursor thermal decomposition) temperatures. Microwave heating may also allow for shorter heating times, due to very rapid local heating, as compared to conventional furnace heating processes. The intimate mixing of precursor materials may also allow for more efficient volumetric heating than conventional furnace heating processes.

In some embodiments, microwave heating is used to heat and decompose precursor materials and form thermally decomposed LRMO materials. For example, the precursor materials may include ligands and/or metals that are highly susceptible to microwave radiation. As such, various embodiments utilize microwave radiation in order to heat precursors and/or precursor gels to very high temperatures in very short periods of time. It has also been found that microwave heating may also provide highly uniform heat dispersion. As such, employing microwave radiation can dramatically change the rate of heating and the resulting thermally decomposed LRMO material organization and/or structure. For example, microwave heating of a precursor gel may result in a highly homogenous thermally decomposed LRMO material. The thermally decomposed LRMO material may be in a form of an inorganic ash that is devoid of organic components (e.g., contains no carbon or an unavoidable amount of carbon). As such, microwave heating may allow for thermally decomposed LRMO materials to be formed without the need for a separate furnace firing, which may be omitted.

For example, a precursor gel may be provided to a microwave furnace, where microwave radiation is used to decompose the gel and form the thermally decomposed LRMO material. For example, microwave radiation may be used to heat the gel to a temperature of at least 350° C., such as a temperature of greater than or equal to 350° C. and less than or equal to 500° C., for a time period sufficient to volatilize the ligands and/or solvents of the gel and form the thermally decomposed LRMO material (e.g., LRMO inorganic ash). Other ranges are also possible. In various embodiments, the thermally decomposed LRMO material may be formed in 30 minutes or less, such as in a time period of greater than or equal to 15 and less than or equal to 30 minutes, using a continuous or pulsed microwave having power level of 20,000 W per kg of microwaved material, or less. Other ranges are also possible. Accordingly, the microwave-based heating process may be configured to rapidly remove (e.g., vaporize and/or combust) organic components from precursor species in order to form the thermally decomposed LRMO material having improved structural characteristics, such as homogenous cation and/or metal oxide distribution.

While microwave thermal decomposition of precursor gel formed by the sol-gel process is described above, in other embodiments, the precursors that are thermally decomposed by microwaves may be formed by other methods. For example, alternative precursor preparation methods may include a mechanical milling/mixing method, a freeze-drying rotary evaporation, or a co-precipitation method. Another example of an alternative precursor preparation method is the use of static a convection oven. In one embodiment of co-precipitation a method, co-precipitated precursors comprising hydroxides of Mn and Ni is mixed with lithium and/or other alkaline or alkali carbonates and/or or hydroxides. The resulting mixture may be mixed completely and thermally processed. In one embodiment of a co-precipitation method, precursors comprising hydroxides of Mn and Ni may be mixed with lithium carbonate and co-precipitated. For example, solid state precursor materials including Li₂CO₃ or LiOH, nickel oxide, and manganese oxide may also be used. The precursors prepared by any of these methods may also be subjected to the microwave thermal decomposition to form the thermally decomposed LRMO material (i.e., the LRMO inorganic ash). As described in more detail below, the methods, conditions, parameters, and/or processing steps described above may, in some embodiments, be applied to the substituted LRMO materials described in this disclosure.

The thermally decomposed LRMO material (i.e., the LRMO inorganic ash) may then be mixed and ground (e.g., milled) to form a precursor LRMO powder. The precursor LRMO powder may then thermally processed (e.g., sintered) in any suitable thermal processing apparatus, such as in a furnace, such as a tube furnace, muffle box, etc., to form a sintered LRMO material. For example, the precursor LRMO powder material may be heated (e.g., sintered) at the thermal processing temperature (e.g., a temperature of at least 800° C., such as 900° C.), for a time period of greater than or equal to 12 and less than or equal to 24 hours, and then the sintered LRMO material may be rapidly or ultra-rapidly quenched as described above to form the quenched LRMO material. The quenched LRMO material may then be dried and optionally reground (e.g., milled) into a LRMO active material (e.g., active cathode material powder). This LRMO active cathode material powder may then be mixed with a binder or other inactive cathode material to form a cathode of a Li-ion battery.

According to various embodiments, methods of forming LRMO materials may include a combination of rapid heating, such as microwave heating, for at least a part of the thermal processing, combined with rapid or ultra-rapid quenching, in order to produce LRMO materials having unexpectedly high performance. Specifically, this process may produce LRMO material having a high degree of atom/cation disorder/homogeneity (which can be quantified using X-ray diffraction), along with no or substantially no surface segregation of nickel or nickel oxide in the particles (e.g., crystallites), which can be observed using transmission electron microscopy. The combination of these material attributes produces cathode active materials that exhibit little to no capacity fade over 100's to 1000's of charge/discharge cycles, a substantially reduced or eliminated loss in average discharge voltage during cycling, and rate capabilities that are suitable for commercial use.

According to various embodiments, the embodiment methods which include microwave heating and/or rapid/ultra-rapid quenching step, may be used to form LRMO active materials that do not suffer from the chemical instability of prior art LRMO materials. In particular, the rapid or ultra-rapid quenching step may be used to form LRMO active materials having reduced Ni surface segregation and increased structural homogeneity, as compared to conventional LRMO materials which are slow cooled after sintering. In various embodiments, the above microwave heating process may be used in conjunction with rapid or ultra-rapid quenching to form LRMO active materials. For example, thermally decomposed LRMO materials formed using microwave decomposition may be sintered and then subjected to the rapid or ultra-rapid quenching process. As described in more detail below, the methods, conditions, parameters, and/or processing steps described above may, in some embodiments, be applied to the substituted LRMO materials described in this disclosure.

In one embodiment, a cathode electrode (i.e., positive electrode) includes a LRMO active material comprising a powder embedded in a binder. The powder may have an average particle/agglomerate size of greater than or equal to 0.1 μm and less than or equal to 10 μm and an average crystal (i.e., crystallite) size of greater than or equal to 25 nm and less than or equal to 500 nm. The powder (e.g., embedded in a binder) may comprise particles having an average largest cross-sectional dimension of greater than or equal to 0.1 micron, greater than or equal to 0.2 microns, greater than or equal to 0.5 microns, greater than or equal to 1 micron or greater. The powder (e.g., embedded in a binder) may comprise particles having an average largest cross-sectional dimension of less than or equal to 10 microns, less than or equal to 5 microns, less than or equal to 2 microns, or less. Combinations of these ranges (e.g., greater than or equal to 0.1 micron and less than or equal to 10 microns) are possible. Other ranges are also possible. The powder may have crystals (e.g., crystallites) having an average largest cross-sectional dimension of greater than or equal to 25 nm, greater than or equal to 50 nm, greater than or equal to 100 nm, greater than or equal to 150 nm, or greater. The powder may have crystals (e.g., crystallites) having an average largest cross-sectional dimension of less than or equal to 500 nm, less than or equal to 300 nm, less than or equal to 200 nm, or less. Combinations of these ranges (e.g., greater than or equal to 25 nm and less than or equal to 500 nm) are possible. Other ranges are also possible. In one embodiment, the particles of the LRMO active material powder may have at least one of a spinel surface layer, a carbon coating (e.g., resulting from the carbohydrate additive in the quench bath) and/or passivated oxygen bonds on a surface (e.g., resulting from the acid additive in the quench bath). The cathode electrode may be included in a battery, such as a lithium-ion battery, that also includes an anode electrode (i.e., a negative electrode), an electrolyte and a separator.

### Substituted LRMO Materials

In one aspect, a substituted lithium-rich metal oxide (S-LRMO) material, in which at least a portion of the lithium is substituted with sodium, potassium, calcium and/or magnesium, is provided. According to various embodiments, cathode active materials comprise a substituted lithium-rich metal oxide (S-LRMO) material, in which at least a portion of the lithium is substituted with sodium, potassium, calcium and/or magnesium. Herein, the S-LRMO material may also be referred to as a substituted alkali/alkaline-atom rich metal oxide (ARMO) material. The S-LRMO material may have the general formula:

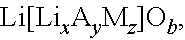

wherein A is at least one alkaline earth element and/or alkali element other than lithium, and (x+y) is greater than 0 and less than 0.3, y>0.05, and z=1−(x+y), M comprises manganese (Mn) and nickel (Ni), b is greater than or equal to 1.8 and less than or equal to 2.2 depending on the net oxidation state of M.

In some embodiments, A is an alkaline earth element such as beryllium, magnesium, calcium, strontium, barium, and radium. In some embodiments, A is an alkali element other than Lithium such as sodium, potassium, rubidium, cesium, and francium. In an exemplary set of embodiments, A is selected from the group consisting of Na, K, Ca, and/or Mg.

In some embodiments, the S-LRMO material has the general formula:

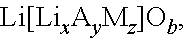

wherein A is at least one alkaline earth element and/or alkali element other than lithium, such as Na, K, Ca, and/or Mg, and (x+y) is greater than or equal to 0 and less than or equal to 0.3, y>0.05, and z=1−(x+y), M is a combination of transition metals and comprises at least manganese (Mn) and nickel (Ni), b is greater than or equal to 1.8 and less than or equal to 2.2 depending on the net oxidation state of M. Preferably, b=2. In one embodiment, (x+y) is greater than 0.1 and less than 0.25, such as 0.2, and y is greater than or equal to 0.05 and less than or equal to 0.15, such as greater than or equal to 0.06 and less than or equal to 0.14. In one embodiment, the material exhibits the crystallinity and phase content commonly found in lithium-rich layered metal oxides (i.e., in the non-substituted LRMO material embodiment) with no evidence of other crystalline phases. In one embodiment, the S-LRMO material in its pristine state (e.g., before it is charged for the first time), may have distinct hexagonal (e.g., rhombohedral) and monoclinic phases. In some embodiments, the two phases may be disposed in a layered structure. Those of ordinary skill in the art would understand, based upon the teachings of this specification, that the stoichiometry “O₂” in a chemical formula for the LRMO and/or S-LRMO is not intended to be limited to an exact chemical stoichiometry and that the actual elemental amount of oxygen may vary slightly (e.g., from greater than or equal to 1.9 to less than or equal to 2.1 moles of oxygen per unit mole active material) e.g., to accommodate slight variations in the average transition metal oxidation states of other components of the material (e.g., transition metal oxidation states). For example, M may comprise 50 to 80 atomic percent Mn, 20 to 50 atomic percent Ni, and greater than or equal to 0 and less than or equal to 10 atomic percent other elements including, for example, Ti, Al, Fe, Co, or any combination thereof. In various embodiments, up to 20% of the total Li content in the material may be substituted with one or more alkali elements other than Li and/or one or more alkaline earth elements. For example, greater than or equal to 0.5%, greater than or equal to 1%, greater than or equal to 2%, greater than or equal to 5%, greater than or equal to 10%, or more of the Li may be substituted with at least one of Na, K, Mg, and Ca. In some embodiments, up to 13%, up to 15%, up to 20%, or more of the Li may be substituted with at least one of Na, K, Mg, and Ca. For example, greater than or equal to 0.5% and less than or equal to 20%, such as greater than or equal to 1% and less than or equal to 15%, or greater than or equal to 2% and less than or equal to 13% of the Li may be substituted with at least one of Na, K, Mg and Ca. Thus, an atomic ratio of A to lithium in the above formula may be greater than or equal to 0.5:95.5 and less than or equal to 20:80. In other words, the ratio of A to (1+x) in the above formula may be greater than or equal to 0.5:95.5 and less than or equal to 20. Other ranges are also possible. When thermally processed as described above (e.g., sintered and rapidly quenched), the S-LRMO has a classical lithium-rich crystalline structure that exhibits some combination of trigonal (R-3m) and monoclinic (C2/m) crystal structure features, and no obvious secondary phases. In other words, S-LRMO includes both the hexagonal phase and the monoclinic phase, where the trigonal crystal system is a species of the hexagonal crystal family (i.e., genus).

In some embodiments, greater than or equal to 0.5%, greater than or equal to 1%, greater than or equal to 2%, greater than or equal to 5%, greater than or equal to 10%, or more of the Li is substituted with Na. In some embodiments, up to 13%, up to 15%, up to 20%, or more of the Li is substituted with Na. For example, greater than or equal to 0.5% and less than or equal to 20%, such as greater than or equal to 1% and less than or equal to 15%, or greater than or equal to 2% and less than or equal to 13% of the Li may be substituted with Na. Other ranges are also possible.

In some embodiments, greater than or equal to 0.5%, greater than or equal to 1%, greater than or equal to 2%, greater than or equal to 5%, greater than or equal to 10%, or more of the Li is substituted with K. In some embodiments, up to 13%, up to 15%, up to 20%, or more of the Li is substituted with K. For example, greater than or equal to 0.5% and less than or equal to 20%, such as greater than or equal to 1% and less than or equal to 15%, or greater than or equal to 2% and less than or equal to 13% of the Li may be substituted with K. Other ranges are also possible.

In some embodiments, greater than or equal to 0.5%, greater than or equal to 1%, greater than or equal to 2%, greater than or equal to 5%, greater than or equal to 10%, or more of the Li is substituted with Mg. In some embodiments, up to 13%, up to 15%, up to 20%, or more of the Li is substituted with Mg. For example, greater than or equal to 0.5% and less than or equal to 20%, such as greater than or equal to 1% and less than or equal to 15%, or greater than or equal to 2% and less than or equal to 13% of the Li may be substituted with Mg. Other ranges are also possible.

In some embodiments, greater than or equal to 0.5%, greater than or equal to 1%, greater than or equal to 2%, greater than or equal to 5%, greater than or equal to 10%, or more of the Li is substituted with Ca. In some embodiments, up to 13%, up to 15%, up to 20%, or more of the Li is substituted with Ca. For example, greater than or equal to 0.5% and less than or equal to 20%, such as greater than or equal to 1% and less than or equal to 15%, or greater than or equal to 2% and less than or equal to 13% of the Li may be substituted with Ca. Other ranges are also possible.

In some embodiments, the S-LRMO material (e.g., as a cathode active material) is represented by the formula Li[LiₑA_{f}M_{g}]Oₕ, wherein: e is less than or equal to 0.06, f is 0.14 or more, g=1−(e+f), A comprises at least one of Na, K, Ca or Mg, M comprises Mn and Ni, and h is greater than or equal to 1.8 and less than or equal to 2.2. Other ranges are also possible.

In some embodiments, cobalt is absent from the S-LRMO material or is present in a relatively small amount. For example, in some embodiments, the atomic percentage of cobalt in the S-LRMO is zero or is less than or equal to 10 at %, less than or equal to 5 at %, less than or equal to 2 at %, less than or equal to 1 at %, less than or equal to 0.5 at %, less than or equal to 0.2 at %, less than or equal to 0.1 at %, less than or equal to 0.05 at %, less than or equal to 0.02 at %, less than or equal to 0.01 at %, less than or equal to 0.005 at %, less than or equal to 0.002 at %, less than or equal to 0.001 at %, or less. Other ranges are also possible.

In some embodiments, the S-LRMO (e.g., as a cathode active material) is represented by the formula Li_{1.14} Na_{0.06}Mn_{0.6}Ni_{0.2}O₂. In some embodiments, the S-LRMO (e.g., as a cathode active material) is represented by the formula Li_{1.06}Na_{0.14}Mn_{0.6}Ni_{0.2}O. In some embodiments, the S-LRMO (e.g., as a cathode active material) is represented by the formula Li_{1.015}Na_{0.155}Mn_{0.58}Ni_{0.25}O₂. In some embodiments, the S-LRMO (e.g., as a cathode active material) is represented by the formula Li_{1.013}Na_{0.157}Mn_{0.52}Ni_{0.32}O₂. In some embodiments, the S-LRMO (e.g., as a cathode active material) is represented by the formula Li_{1.06}K_{0.14} Mn_{0.6}Ni_{0.2}O₂. The S-LRMO material can be formed using methods similar to the methods described above with respect to the LRMO material. For example, the S-LRMO material may be manufactured using precursor materials formed by sol-gel, solid state, or co-precipitate methods. The precursor materials may comprise metalloorganic precursors of Li, Na, K, Ca, Mg and one or more transition metals and/or Al. For example, the metalloorganic precursors may be selected from acetates, carbonates, nitrates, sulfates, and/or hydroxides of Li, Na, K, Ca, Mg, Mn, Ni and optionally Fe, Co, Al and/or Ti. In some embodiments, the precursors include a greater than or equal to 0.01 and less than or equal to 0.20 molar fractional excess of the of the lithium, sodium, and/or potassium metalloorganic precursors. In some embodiments, the precursors may include a greater than or equal to 0.01 and less than or equal to 0.20 molar fractional excess of the of the lithium and/or sodium metalloorganic precursors. For example, the sol-gel may include a greater than or equal to 0.01 and less than or equal to 0.20 molar fractional excess of the of the lithium and/or sodium metalloorganic precursors. In some embodiments, the precursors include a greater than or equal to 0.01 and less than or equal to 0.20 molar fractional excess of the lithium and/or sodium metal hydroxide precursors. For example, the sol-gel may include a greater than or equal to 0.01 and less than or equal to 0.20 molar fractional excess of the of the lithium and/or sodium metal hydroxide precursors. Other ranges are also possible. The precursors may be mixed (e.g., with a solution comprising water) to form a mixture. The mixture of the precursors may be heated to form a gel.

The precursors (e.g., as a mixture such as a gel) may be thermally decomposed (e.g., to form the LRMO material). The precursors may be fired at temperatures of greater than or equal to 250° C. and less than or equal to 600° C., such as greater than or equal to 300° C. and less than or equal to 500° C., for a time period of greater than or equal to 2 hours and less than or equal to 8 hours, such as greater than or equal to 4 hours and less than or equal to 6 hours, to thermally decompose the precursors and form an S-LRMO material. In some embodiments, the precursors may be thermally decomposed using microwave heating as discussed above. The decomposed precursor materials may then be sintered at a sintering temperature (e.g., to form the sintered S-LRMO material). The decomposed precursor materials may then be sintered at a temperature of at least 800° C., such as a temperature of greater than or equal to 850° C. and less than or equal to 1000° C., such as greater than or equal to 900° C. and less than or equal to 950° C., for a time period of greater than or equal to 8 hours and less than or equal to 14 hours, such as greater than or equal to 9 hours and less than or equal to 12 hours, or greater than or equal to 10 hours and less than or equal to 11 hours, to form a S-LRMO material. Other ranges are also possible.

In some embodiments, the S-LRMO material is sintered at a sintering temperature. The sintering temperature may refer to the temperature of the environment in which the S-LRMO is present during the sintering (e.g., a furnace temperature). In some embodiments, the sintering temperature is at least 800° C., at least 825° C., at least 850° C., at least 875° C., at least 900° C., or greater. In some embodiments, the sintering temperature is less than or equal to 1000° C., less than or equal to 950° C., less than or equal to 925° C., or less. Combinations of these values (e.g., at least 800° C. and less than or equal to 1000° C., at least 850° C. and less than or equal to 950° C., at least 900° C. and less than or equal to 950° C.) are possible. Other ranges are also possible.

In some embodiments, there is some excess alkali and or alkaline species in the precursor mixes such that during thermal processing not all of the Li, Na, K, and or Mg species become part of the formed active material and instead form a residual left behind in the powder in the form of an oxide or oxy-hydroxide.

The S-LRMO material may be ultra-rapidly quenched from a quenching temperature to room temperature in a quench fluid or bath as described above, to form an S-LRMO active material. For example, the S-LRMO material may be quenched from a sintering temperature of at least 800° C., such as a temperature of greater than or equal to 800° C. and less than or equal to 1000° C., or greater than or equal to 850° C. and less than or equal to 950° C., to room temperature (e.g., 25° C.), in less than or equal to 500 milliseconds, or less than or equal to 200 milliseconds, such as in time period of greater than or equal to 100 milliseconds and less than or equal to 500 milliseconds, greater than or equal to 200 milliseconds and less than or equal to 100 milliseconds. Other ranges are also possible. In some embodiments, the quenching temperature and the sintering temperature may be the same or substantially the same temperature.

In some embodiments, the S-LRMO material is quenched from a sintering temperature (e.g., of at least 800° C., such as a temperature of greater than or equal to 800° C. and less than or equal to 1000° C., or greater than or equal to 850° C. and less than or equal to 950° C.) to a quenching temperature that is in the range of greater than or equal to 10° C., greater than or equal to 15° C., greater than or equal to 20° C. and/or less than or equal to 120° C., less than or equal to 100° C., less than or equal to 80° C., less than or equal to 60° C., less than or equal to 50° C., less than or equal to 45° C., less than or equal to 40° C., less than or equal to 35° C., less than or equal to 30° C., less than or equal to 25° C., or less. In some embodiments, the quenching temperature is room temperature (e.g., 25° C.). The quenching may occur in less than or equal to 500 milliseconds, less than or equal to 400 milliseconds, less than or equal to 300 milliseconds, less than 200 milliseconds, and/or as low as 150 milliseconds, as low as 100 milliseconds, or less. Combinations of these ranges (e.g., quenching occurring in a time period of greater than or equal to 100 milliseconds and less than or equal to 500 milliseconds, or greater than or equal to 100 milliseconds and less than or equal to 200 milliseconds) are possible. Other ranges are also possible.

In some embodiments, the quenching (e.g., within the time periods discussed above) comprises bringing at least 25 wt %, at least 50 wt %, at least 80 wt %, at least 90 wt %, at least 95 wt %, at least 98 wt %, at least 99 wt %, at least 99.9 wt %, or more (e.g., 100 wt %) of the sintered S-LRMO to thermal equilibrium (e.g., with its surrounding medium such as a quench bath) at a temperature that is within the range of greater than or equal to 10° C., greater than or equal to 15° C., greater than or equal to 20° C. and/or less than or equal to 120° C., less than or equal to 100° C., less than or equal to 80° C., less than or equal to 60° C., less than or equal to 50° C., less than or equal to 45° C., less than or equal to 40° C., less than or equal to 35° C., less than or equal to 30° C., less than or equal to 25° C., or less (e.g., room temperature, such as 25° C.). In some embodiments, the quenching comprises bringing at least 25 volume percent (vol %), at least 50 vol %, at least 80 vol %, at least 90 vol %, at least 95 vol %, at least 98 vol %, at least 99 vol %, at least 99.9 vol %, or more (e.g., 100 vol %) of the sintered S-LRMO to thermal equilibrium (e.g., with its surrounding medium such as a quench bath) at a temperature that is within the range of greater than or equal to 10° C., greater than or equal to 15° C., greater than or equal to 20° C. and/or less than or equal to 120° C., less than or equal to 100° C., less than or equal to 80° C., less than or equal to 60° C., less than or equal to 50° C., less than or equal to 45° C., less than or equal to 40° C., less than or equal to 35° C., less than or equal to 30° C., less than or equal to 25° C., or less (e.g., room temperature, such as 25° C.). Other ranges are also possible.

The quench fluid may include oil, alcohol, or water, and may optionally include an additive. For example, the quench fluid may be an oil bath, an alcohol bath, or a water bath. The quench fluid may also be referred to as a quench bath. The quench fluid or bath may comprise water in an amount of greater than or equal to 50 wt %, greater than or equal to 80 wt %, greater than or equal to 90 wt %, greater than or equal to 95 wt %, greater than or equal to 98 wt %, greater than or equal to 99 wt %, or greater (e.g., 100 wt %). Other ranges are also possible. The quench fluid or bath may include one or more additives such as at least one acid or at least one carbohydrate (e.g., urea or sugar), or a combination thereof, as described above. In some embodiments, the quench fluid or bath is basic in pH (e.g., a pH of greater than 7, greater than or equal to 8, greater than or equal to 9, greater than or equal to 10, greater than or equal to 11, greater than or equal to 12, greater than or equal to 14, or greater). In some embodiments, the quench fluid or bath includes a base as an additive, such as LiOH, NaOH, and/or KOH.

In some embodiments, the sintering may be performed in a furnace such as a rotating furnace. The S-LRMO material may be transferred from the furnace to the quench fluid in 500 milliseconds or less, such as 200 milliseconds or less, for example. In some embodiments, the time between removing the sintered S-LRMO material from the furnace and the quenching occurring (e.g., via transfer to the quench bath) is less than or equal to 500 milliseconds, less than or equal to 200 milliseconds, and/or as low as 100 milliseconds. Other ranges are also possible.

The excess alkali and/or alkaline earth metals and Ni and Mn atoms may be homogeneously and uniformly distributed throughout transition metal crystal lattice sites in the S-LRMO material, such that there are no crystalline volumes greater than 3×3×3 nm in the material, in which there is a greater than 3% difference between ratios of Ni, Mn, A, and Li atoms, where A is at least one of Na, K, Ca or Mg, as compared to average ratios of the Ni, Mn, Na, K, Ca, Mg, and Li atoms of a bulk material.

According to various embodiments, the S-LRMO materials utilize a reduced amount of Li due to the substitution of Li with less costly elements. The S-LRMO materials thereby provide a reduction in material cost, as compared to unsubstituted LRMO materials. In addition, the S-LRMO materials also provide an unexpected capacity stability, rate capability, and an unexpectedly high voltage, as compared to conventional non-substituted LRMO materials. Additionally, it has been unexpectedly observed in the context of this disclosure that relatively high amounts of lithium in the LRMO material can be substituted with different cations (e.g., alkalis and/or alkaline earth metals such as sodium, potassium, magnesium, and/or calcium to form an S-LRMO) while maintaining substantially the same crystal structure and properties as non-substituted analogs. For example, it was surprising that relatively high levels of lithium substitution (e.g., greater than 5% and up to 20%) could be obtained without observing substantial occurrences of potentially deleterious phenomena such as the formation of second crystal phases. This stands in contrast to expectations from literature, where it had previously been reported for nickel and manganese-containing lithium metal oxide electrode active materials that when Na is used to replace some of the Li, a secondary crystalline phase (Na_{0.7}MnO₂) was observed (Du. K, et al. (2013). “Sodium additive to improve rate performance of Li[Li_{0.2}Mn_{0.54}Ni_{0.13}Co_{0.13}]O₂ material for Li-ion batteries.” Journal of Power Sources, 244, 29-34.). No substantial occurrence of such a secondary phase has been observed with the materials of this disclosure. Without wishing to be bound by any particular theory, it is believed that one contributing factor to the observed high level of substitution for lithium without disrupting desirable crystal and/or electrochemical properties is the use of the techniques of this disclosure (e.g., using rapid quenching such as in water).

In one embodiment, a method of forming an active material for a positive electrode of a lithium-ion battery comprises quenching a powder of the active material in water. In one embodiment, the method further comprises firing the active material powder prior to the quenching. The active material may be fired at a temperature of at least 800° C. The water may be at room temperature prior to the quenching, and the powder of the active material may be quenched at a rate of least 1750° C./second.

In one embodiment, the active material comprises layered substituted lithium-rich nickel manganese oxide. The excess Li, Ni and Mn atoms may be homogeneously and uniformly distributed throughout transition metal crystal lattice sites, such that there are no crystalline volumes greater than 3×3×3 nm in the material in which there is a greater than 3% difference between ratios of Ni, Mn and Li atoms compared to average ratios of the Ni, Mn and Li atoms of a bulk material. Particles of the powder of the active material may be in a shape of agglomerates which have an average size ranging from 0.1 μm to 20 μm, and the agglomerates of the powder of the active material are composed of crystallites having an average size ranging from 25 nm to 500 nm. The powder of the active material may comprise a composite of hexagonal and monoclinic phases after the quenching and is a combination of LiAMO₂ R-3m and (LiA)₂MnO₃ C2/m phases, where M is at least one of Ni or Mn and A is some combination of non-lithium alkali and alkaline earth elements. The powder of the active material may comprise a solid solution with a crystal structure that predominately or completely possess a C2/m symmetry. The powder of the active material may comprise a solid solution with a crystal structure that predominately or completely possess a R-3m symmetry.

In one embodiment, the quench water comprises an additive solvated therein. The water may comprise greater than or equal to 0.01 moles per liter and less than or equal to 1.0 moles per liter of the additive. In one embodiment, the additive comprises an acid, which may be selected from sulfuric acid, citric acid, acetic acid, phosphoric acid, hydrochloric acid, ammonium phosphate, or combinations thereof. In another embodiment, the additive comprises a carbohydrate, which may be selected from fructose, galactose glucose, lactose, maltose, sucrose, or a combination thereof.

In one embodiment, the active material is placed into the positive electrode of the lithium-ion battery cell which further comprises a negative electrode and an electrolyte. In this context, the positive electrode corresponds to a cathode, and the negative electrode corresponds to an anode. The active material comprises hexagonal and monoclinic phases prior to the electrochemical cycling of the battery, and the active material powder does not comprise the monoclinic phase after the electrochemical cycling.

In one embodiment, the positive material in a battery cell has a specific capacity of at least 230 mAh/g (at a C/20 charge rate) after the 50 electrochemical cycles at the discharge rate of up to C/2.

In one embodiment, a lithium-ion battery cell comprises: a negative electrode; an electrolyte; and a positive electrode comprising a layered lithium rich nickel manganese oxide active material, wherein the he battery cell has a specific capacity of at least 215 mAh/g (at a C/20 rate) after the 50 electrochemical cycles at the discharge rate of up to C/2.

In one embodiment, particles of the powder of the active material are in a shape of agglomerates which have an average size of greater than or equal to 0.1 μm and less than or equal to 10 μm, and the agglomerates of the powder of the active material are composed of crystallites having an average crystal size of greater than or equal to 25 nm and less than or equal to 500 nm. Particles of the active material powder may have at least one of a spinel surface layer, a carbon coating or passivated oxygen bonds on a surface.

In some embodiments, fewer than 10% (e.g., fewer than 5%, fewer than 2%, fewer than 1%, fewer than 0.1%, or less) of the non-overlapping crystalline volumes greater than 3×3×3 nm in the material have a greater than 3% difference between ratios of Ni, Mn and alkali and/or alkaline earth metal atoms, as compared to average ratios of the Ni, Mn, Li, and alkali and/or alkaline earth metal atoms of a bulk material. Such a spatial distribution may be due to a high degree of cation disorder (e.g., due to homogeneous distribution of Li, K, Na, Ca, Mg, Ni, and/or Mn atoms). Other ranges are also possible.

In some embodiments, there are no crystalline volumes greater than 3×3×3 nm in the material in which there is a greater than 3% difference between ratios of Ni, Mn and alkali and/or alkaline earth metal atoms, as compared to average ratios of the Ni, Mn, Li, and alkali and/or alkaline earth metal atoms of a bulk material. Such a spatial distribution may be due to a high degree of cation disorder (e.g., due to homogeneous distribution of Li, K, Na, Ca, Mg, Ni, and/or Mn atoms).

In one embodiment, the included excess Li, K, Na, Ca, Mg, Ni, and/or Mn atoms are homogeneously and uniformly distributed throughout transition metal crystal lattice sites, such that there are no crystalline volumes greater than 3×3×3 nm in the material in which there is a greater than 3% difference between ratios of Ni, Mn and alkali and/or alkaline earth metal atoms, as compared to average ratios of the Ni, Mn, and Li atoms of a bulk material.

### EXAMPLES

The following examples are intended to illustrate certain embodiments of the present invention, but do not exemplify the full scope of the invention.

### Experimental Examples

A non-substituted LRMO powder having the formula Liₓ(Mn_{y}Ni_{1-y})₂₋ₓO₂, where x=1.16 and y=0.7 according to an example was produced using the following method. In particular, a precursor material gel was produced using a sol-gel solid-state synthesis method. Synthesis of the sol included forming an aqueous mixture including stoichiometric amounts of Li(CH₃COO)*2H₂O, Mn(CH₃COO)₂*4H₂O, and Ni(NO₃)₂*6H₂O. The mixture was heated at 100° C. until the gel was formed. The gel was poured into an alumina crucible and then fired at 400° C. for 90 minutes, resulting in an ash devoid of organics. The resultant ash was ground and re-fired in the crucible at 500° C. for 3 hours and then allowed to naturally cool before being reground, after which the powder was sintered at 900° C. for 24 hours before being quenched. All sintering happened in a box furnace in ambient fume hood conditions. All quenching took place after 12-24 hours of heating at 900° C.

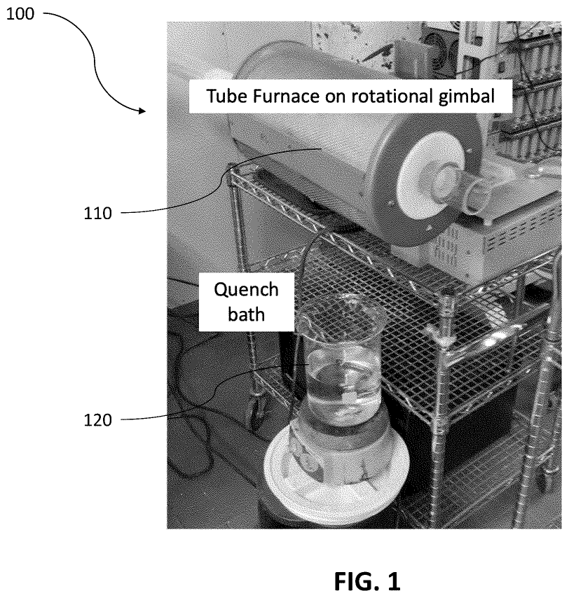

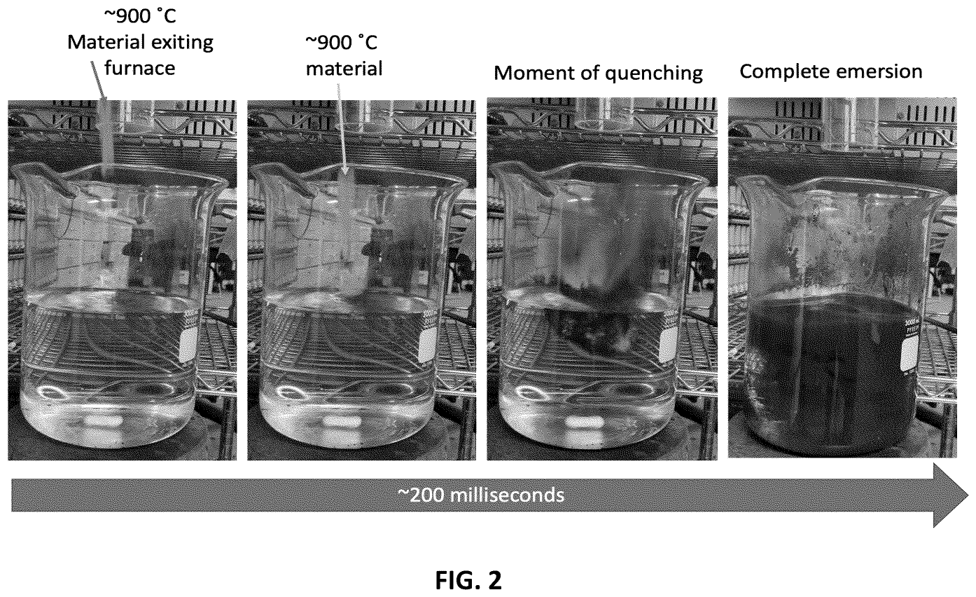

FIG. 1 is a photograph of a rapid quenching system 100, according to various embodiments of the present disclosure. FIG. 2 includes 4 sequential video capture time-lapse images filmed at 30 frames per second, showing a rapid quenching process, according to various embodiments of the present disclosure.

Referring to FIGS. 1 and 2, the LRMO material was provided to a tube furnace 110, where the material is heated to 900° C. The heated LRMO material was output from the tube furnace 110 and quenched to room temperature in a quench bath 120. The tube furnace 110 rotates while operating such that its contents are instantly dumped into the quench bath 110. The time period between the time where the LRMO material exits the furnace 110 at 900° C. to time it is quenched to room temperature takes less than 500 milliseconds, such as less than 200 milliseconds to form a LRMO active material. After quenching, the LRMO material was filtered from the water of the quench bath 120 and dried in a vacuum oven.

In a first comparative example, the LRMO material was allowed to slowly cool in the furnace 110 after the sintering at 900° C. In a second comparative example, the LRMO material was cooled by being dumped onto a metal plate after the sintering. In a third comparative example, the LRMO material was first cooled to room temperature slowly and then inserted into tube furnace 110 for the ultra-rapid quench step, which was kept at 900° C. for 30 to 120 minutes prior to the ultra-rapid quench step.

In a first example, a Na-substituted LRMO material, with sodium substituting in for the lithium content was produced. The same recipe as above was used, however 5% of the lithium content was substituted with sodium such that the final nominal chemical formula was Li[Li_{0.14}Na_{0.06}Mn_{0.6}Ni_{0.2}]O₂.

In a second example, a Na-substituted LRMO material was produced, with sodium substituted for a portion of the lithium. Stoichiometric amounts of a MnNi—OH precursor were mixed with the appropriate amounts of Li₂CO₃ and Na₂CO₃, where 12.5% of the lithium content was substituted with sodium, such that the final nominal chemical formula was Li[Li_{0.06}Na_{0.14}Mn_{0.6}Ni_{0.2}]O₂, and the material was thermally processed as described above.

In a third example, a K-substituted LRMO material was produced, with potassium substituted in for a portion of the lithium. Stoichiometric amounts of a MnNi—OH precursor were mixed with the appropriate amounts of Li₂CO₃ and K₂CO₃, where 12.5% of the lithium content was substituted with potassium, such that the final nominal chemical formula was Li[Li_{0.06}K_{0.14}Mn_{0.6}Ni_{0.2}]O₂, and the material was thermally processed as described above.

In a fourth example, a combined K and Na-substituted LRMO material was produced, with potassium and sodium substituted in for a portion of the lithium. Stoichiometric amounts of a MnNi—OH precursor were mixed with the appropriate amounts of Li₂CO₃ and K₂CO₃ and Na2CO₃, where 12.5% of the lithium content was substituted with equal amounts of sodium and potassium, such that the final nominal chemical formula was Li[Li_{0.06}K_{0.07} Na_{0.07} Mn_{0.6}Ni_{0.2}]O₂, and the material was thermally processed as described above.

### Materials Characterization

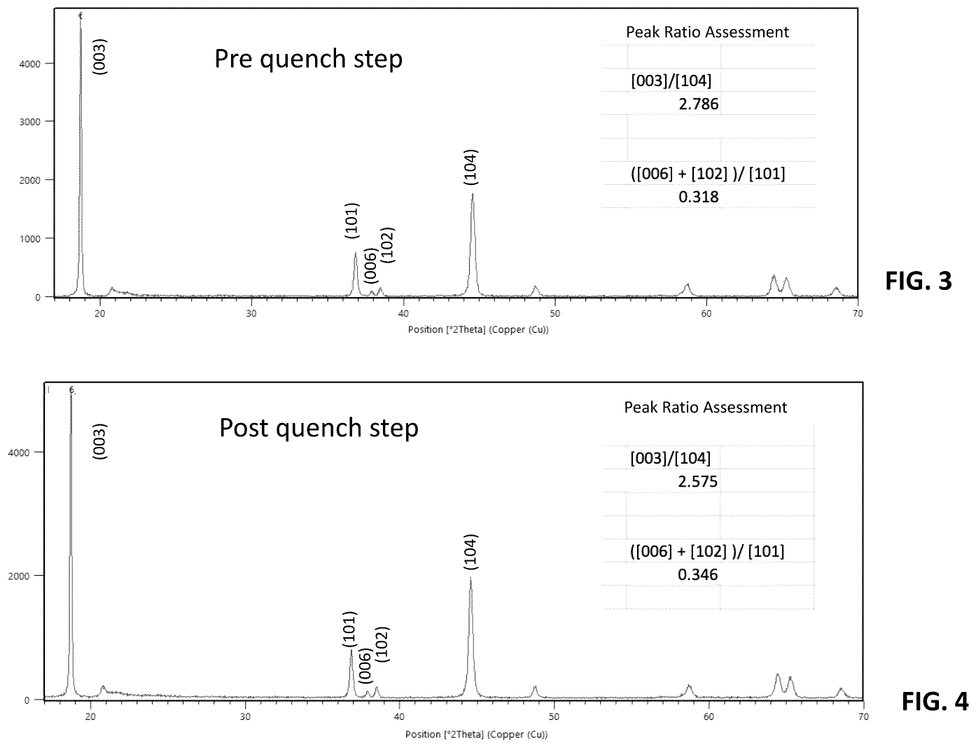

FIGS. 3 and 4 are graphs of X-ray diffraction (XRD) patterns for LRMO materials according to comparative and non-comparative embodiments of the present disclosure. The XRD pattern in FIG. 3 was generated from a layered LRMO active material that was not rapidly quenched via immersion in water, while the XRD pattern in FIG. 4 was generated from a layered LRMO active material that was rapidly quenched via immersion in water.

An assessment of the XRD patterns shows that the LRMO materials possess the expected hexagonal (e.g., rhombohedral) phase LiNiO₂-related, space group (R-3m) and a monoclinic phase (Li₂NiO₃-related, space group (C2/c).

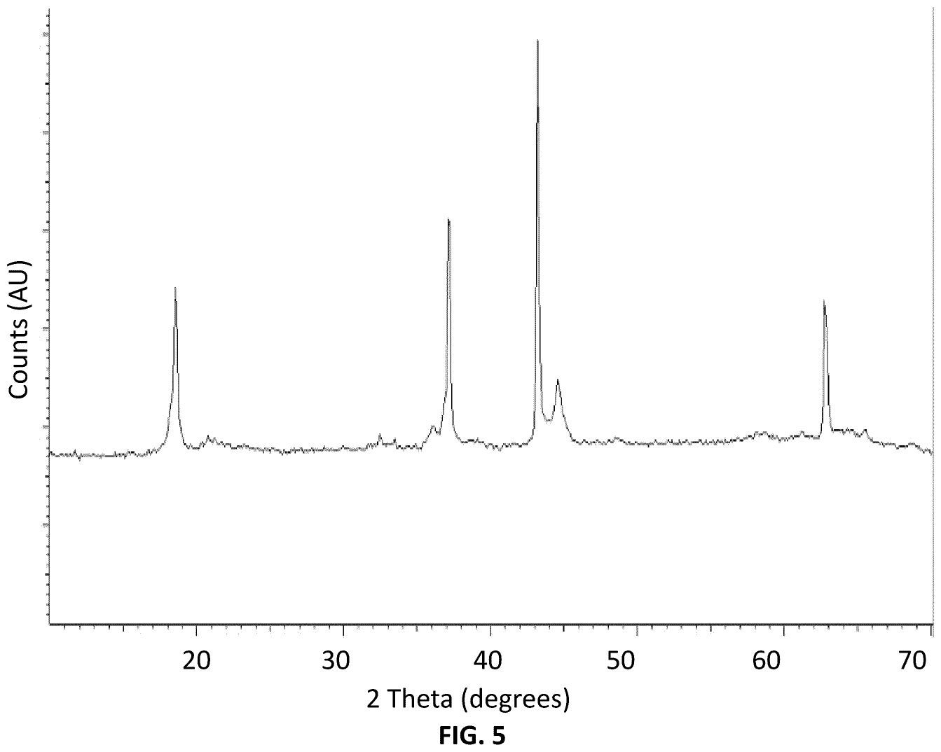

FIG. 5 is a graph showing X-ray diffraction results for a Liₓ(Mn_{y}Ni_{1-y})₂₋ₓO₂ material, where x=1.16, and y=0.7, that was processed using microwave heating of the sol-gel precursor materials for 5 minutes prior to the high temperature firing step, according to various embodiments of the present disclosure. Referring to FIG. 5, of key interest is the fact that this microwave decomposed material has a resultant X-ray diffraction pattern that is consistent with that of a highly crystalized and optimized material, including a rhombohedral phase LiNiO₂-related space group (R-3m) and a monoclinic phase Li₂NiO₃-related, space group (C2/c). Thus, the material is suitable for forming a LRMO using 900° C. annealing and rapid and/or ultra-rapid quenching, as described above.

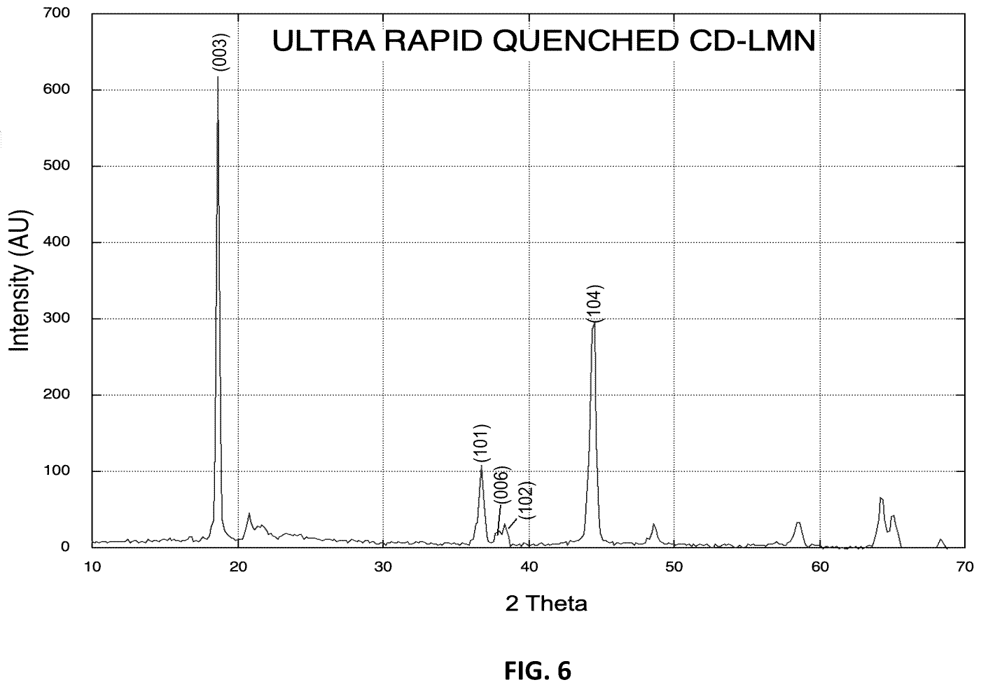

FIG. 6 is a graph illustrating X-ray diffraction results for a Liₓ(Mn_{y}Ni_{1-y})₂₋ₓO₂ material, where x=1.16, and y=0.7, that was processed using microwave heating and ultra-rapid quenching, according to various embodiments of the present disclosure. Referring to FIG. 6, all expected peaks are present and well defined.

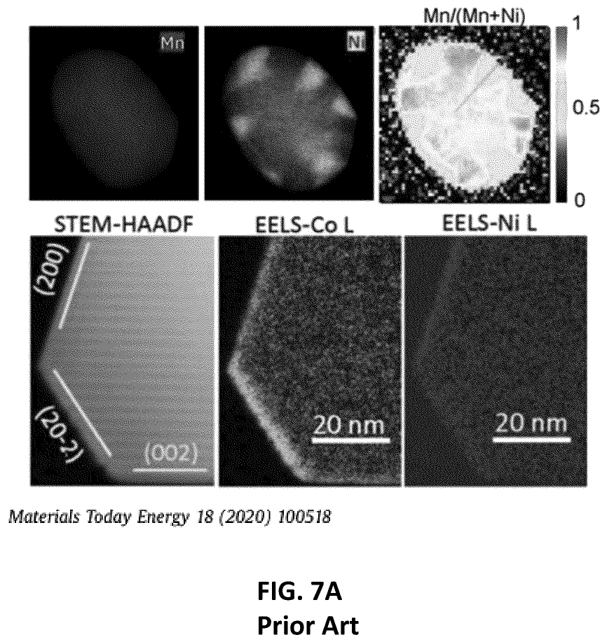

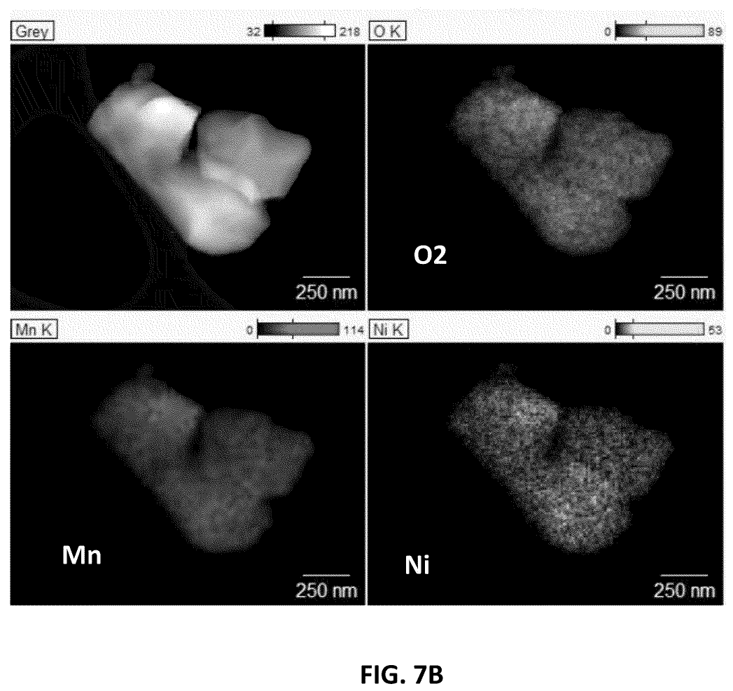

FIG. 7A is a prior art example from the literature (H. Zheng, et al., “Recent developments and challenges of Li-rich Mn-based cathode materials for high-energy lithium-ion batteries”, Materials Energy Today, Volume 18, December 2020, Page 100518) of tunneling electron microscopy (TEM) high-angle annular dark-field imaging (HAADF) atomic map micrograph of typical LRMO material that has not been subjected to rapid quenching prior to electrochemically cycling the material. As can be seen from these micrographs, the initial LRMO material had significant nickel and manganese segregation inside the particles.

FIG. 7B is a TEM HAADF atomic map micrograph of produced non-substituted LRMO material that was subjected to rapid quenching prior to electrochemically cycling the material, according to various embodiments of the present disclosure. As can be seen from these micrographs, the LRMO material had no significant nickel/manganese segregation in the particle. Thus, the rapid or ultra-rapid quenching reduces or eliminates the nickel segregation to the surface of the particles, and nickel and manganese are evenly mixed in the bulk of the LRMO material.

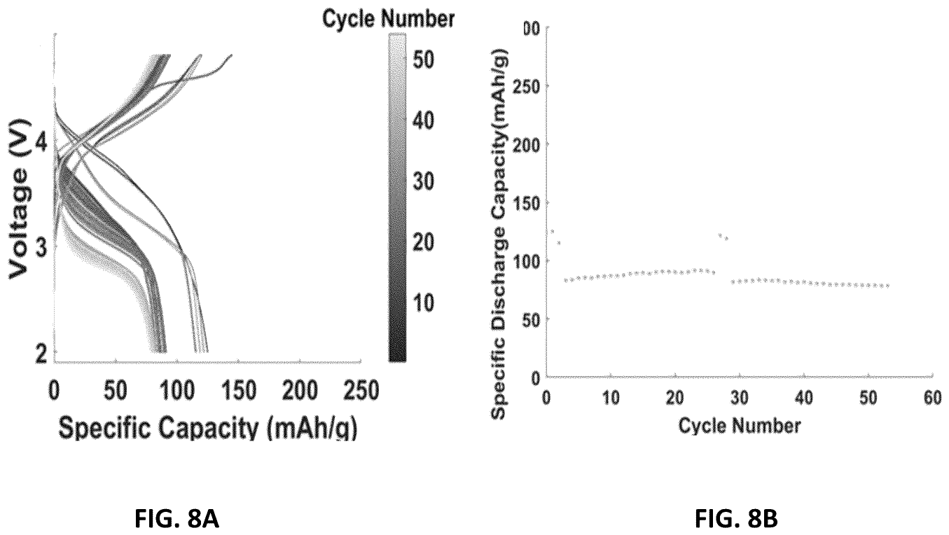

FIG. 8A is a graph showing cell potential vs. specific capacity, and FIG. 8B is a graph of the specific capacity vs cycle for a e example of a Liₓ(Mn_{y}Ni_{1-y})₂₋ₓO₂ material, where x=1.16, and y=0.7, that was neither microwave processed nor rapid quenched (in this case cooled relatively slowly on a metal plate).

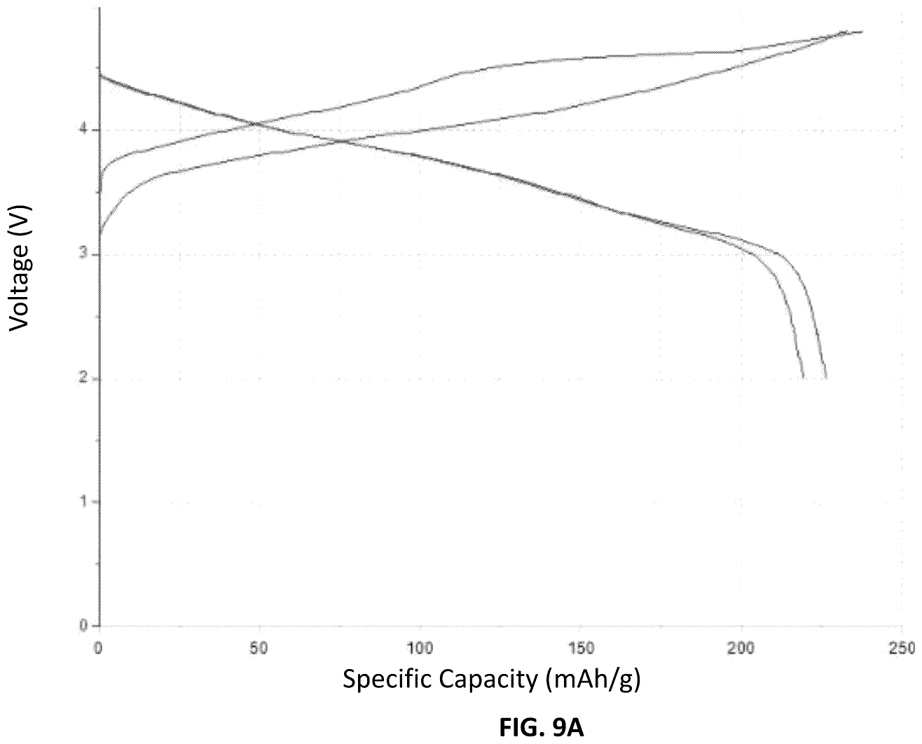

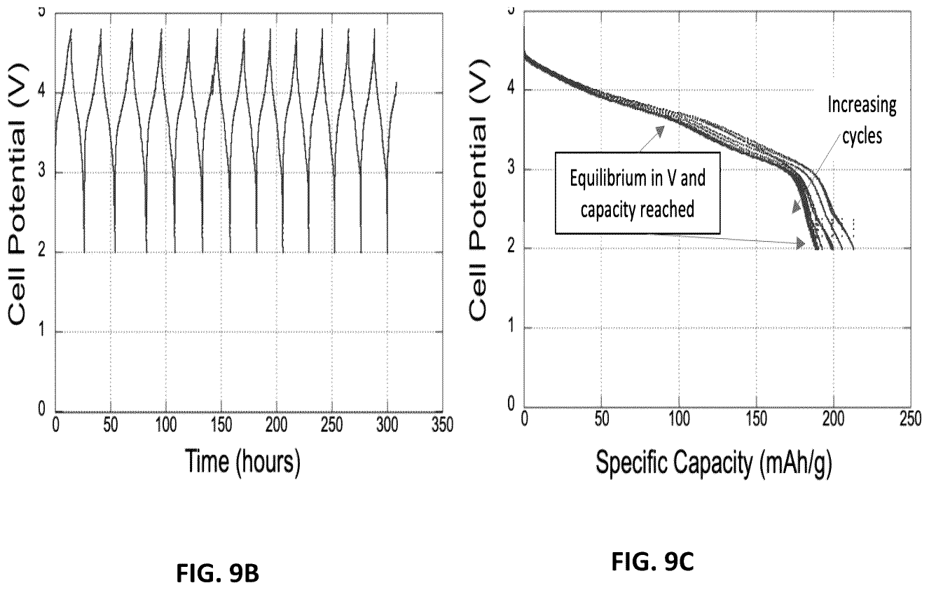

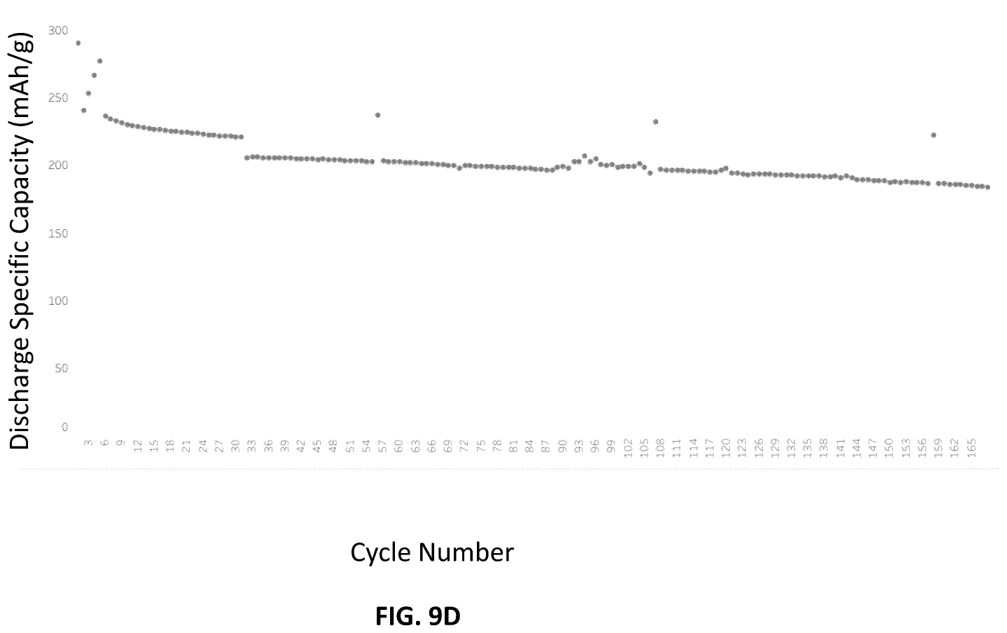

FIG. 9A is a graph showing cell potential vs. specific capacity during break-in cycles, FIG. 9B is a graph showing cell potential vs specific capacity over time, FIG. 9C is a graph showing specific capacity vs cycle at C/20 rate, and FIG. 9D is a graph showing discharge specific capacity at C/5 rate with C/20 reference cycles vs cycle number for cells including unsubstituted LRMO active materials according to comparative embodiments of the present disclosure.

### Crystalline Uniformity, Cation Disorder, and Surface Passivation

One method to assess the degree of metal cation disorder in the materials is to use the ratio of peak intensities in the x-ray diffraction patterns. Specifically, the ratio of the intensity of the (003) peak to the (104) peak is commonly known as rough measurement of electrochemical activity in mixed cation materials with this predominately layered crystal structure, while the ratio of the sum of the intensities of (006) and (102) peaks to the intensity of the (101) peak is an indicator of cation disorder. Based on this, the material that has been both microwave-processed during the decomposition stage and then ultra-rapidly quenched offers significantly higher indications of electrochemical activity and lower degree of cation order (and therefore a higher degree of cation disorder) than slow cooled material.

TABLE 2
XRD Peak Ratios

| | (003)/(104): | [(006) + (102)]/ |
|---|---|---|
| | higher is more | (101): higher is |
| | electrochemically | higher cation |
| | active | mixing/disorder |
| First comparative example: | 2.79 | 0.318 |
| slow cooling | | |
| Second example: non- | 2.575 | 0.346 |
| substituted LRMO with ultra- | | |
| rapid quenching | | |
| Example: S-LRMO with ultra | 1.71 | 0.345 |
| rapid quenching having formula | | |
| Li[Li_{0.06}Na_{0.14}Mn_{0.6}Ni_{0.2}]O₂ | | |

Table 2 shows XRD peak intensity ratios for a first comparative LRMO material subjected to a slow quench after sintering (row 1), and for a second, non-substituted LRMO material and an exemplary S-LRMO material that were formed using the ultra-rapid quenching process after sintering (rows 2 and 3, respectively). The non-substituted LRMO materials have formula Li[Liₓ(Mn_{y}Ni_{1-y})₁₋ₓ]O₂ where x=0.2, and y=0.75. Importantly, the exemplary ultra-rapidly quenched material exhibits XRD characteristics that show an increase in atomic disordering in the material Specifically, the exemplary material shows an increase in the ratio of the sum of the intensities of (006) and (102) peaks to the intensity of the (101) peak, in this case of 9%. This significant increase in cation disorder represents a situation where the Ni and Mn atoms are more completely mixed (and are therefore not grouped) in the material along with the Li and substituting elements in the transition metal sites. These data demonstrate that different states of matter can be created based on the processing conditions used, and in particular, the rate of cooling used, and are also observed in the S-LRMO material.

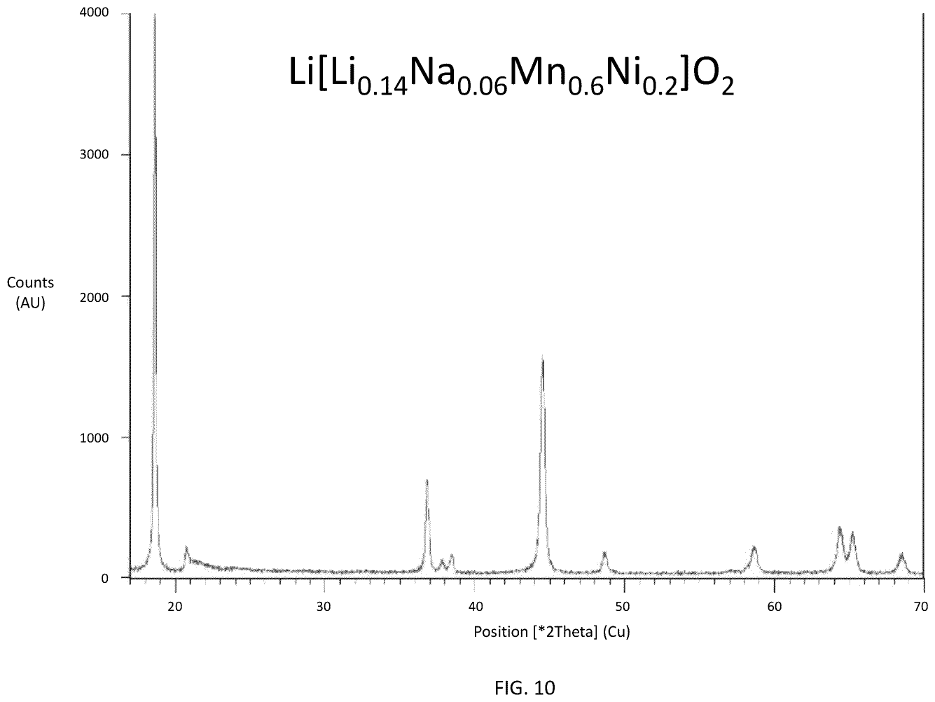

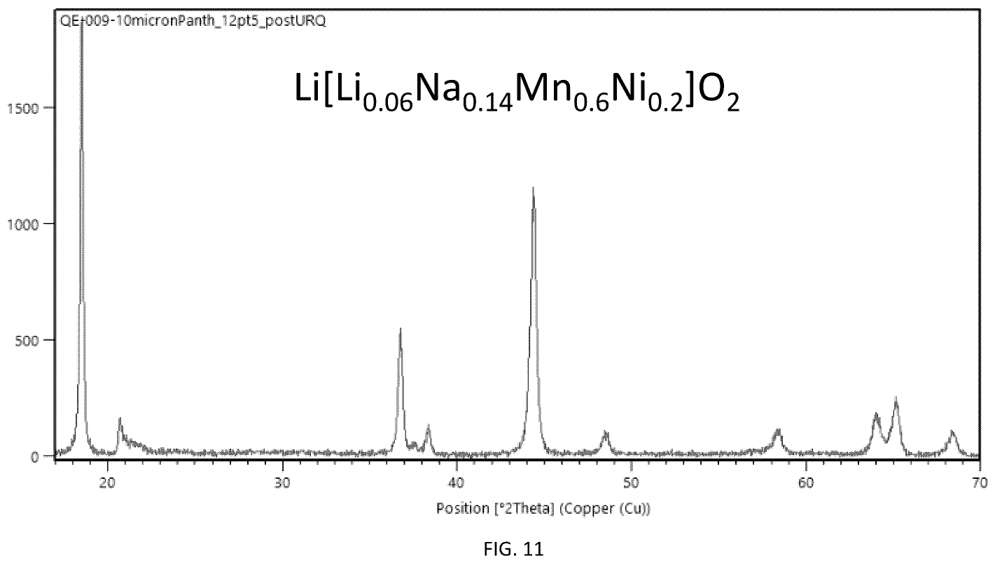

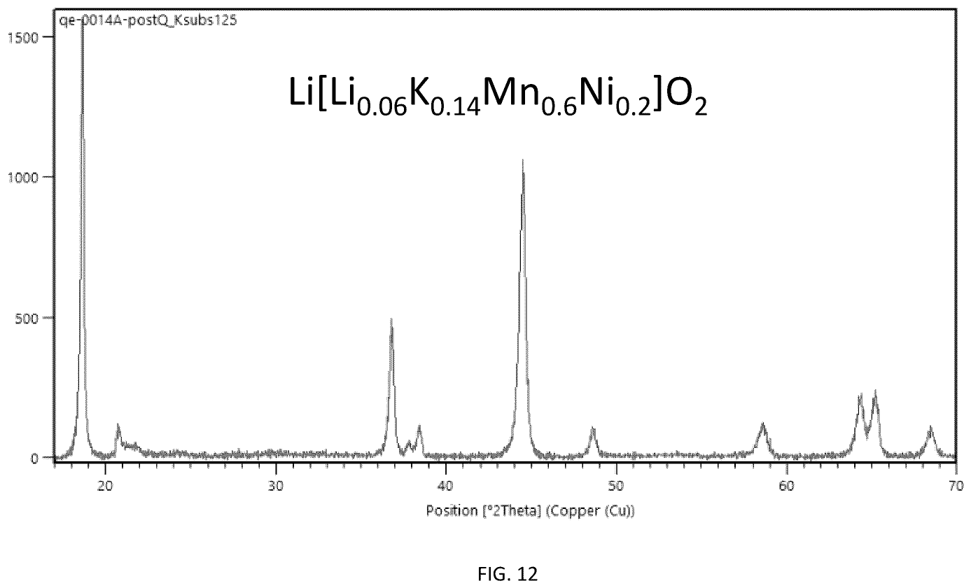

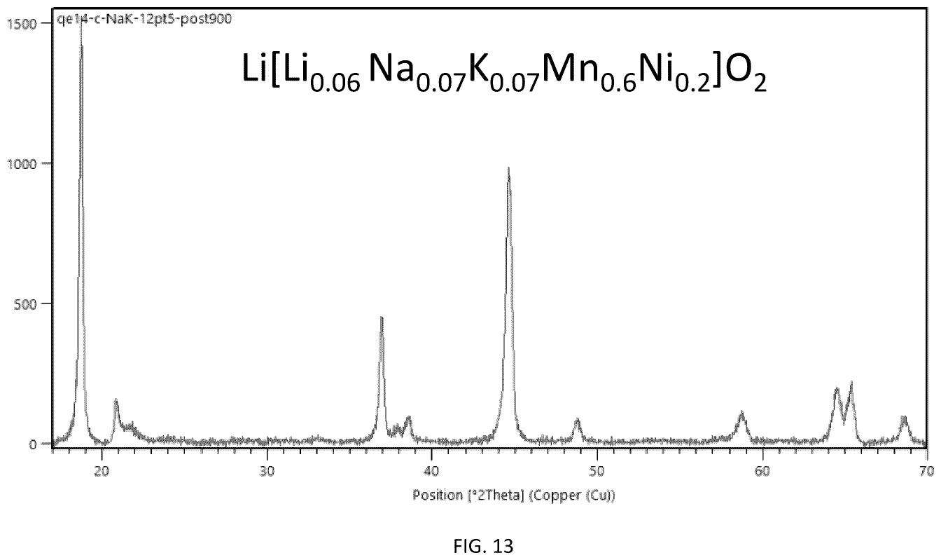

FIGS. 10-13 are charts showing X-ray diffraction pattern results for S-LRMO materials including various amounts of Na and/or K as described in the previous section, according to various embodiments of the present disclosure. The S-LRMO materials were prepared using to the above-disclosed thermal processing and ultra-rapid quenching processes. As shown in FIGS. 10-13, the S-LRMO materials had the classical phase purity of an LRMO material. The XRD data is also consistent with a material that exhibits a high degree of cation mixing/disorder in the transitional sites in the material.

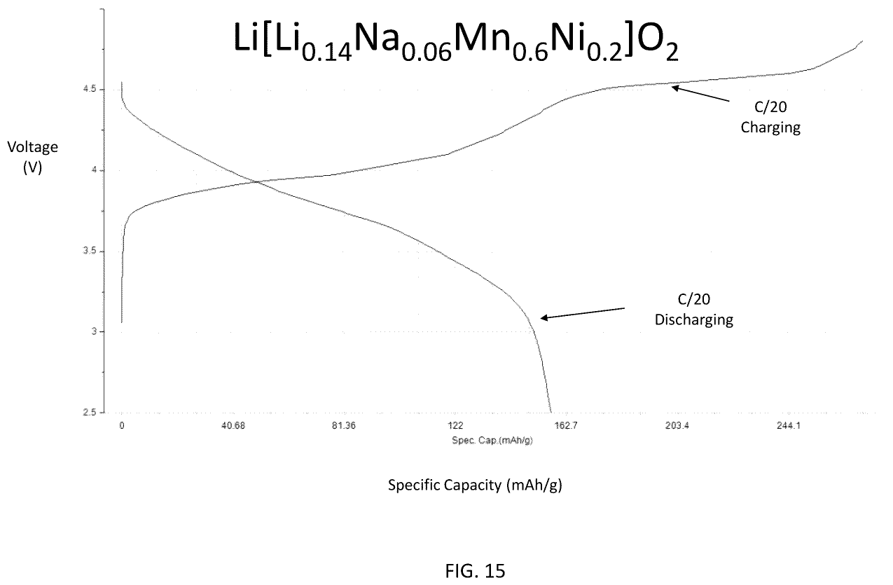

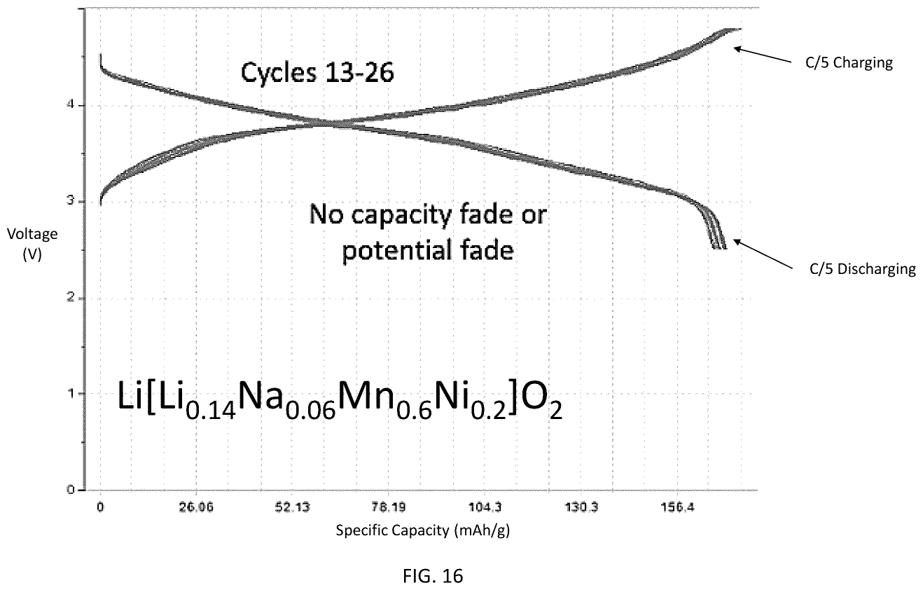

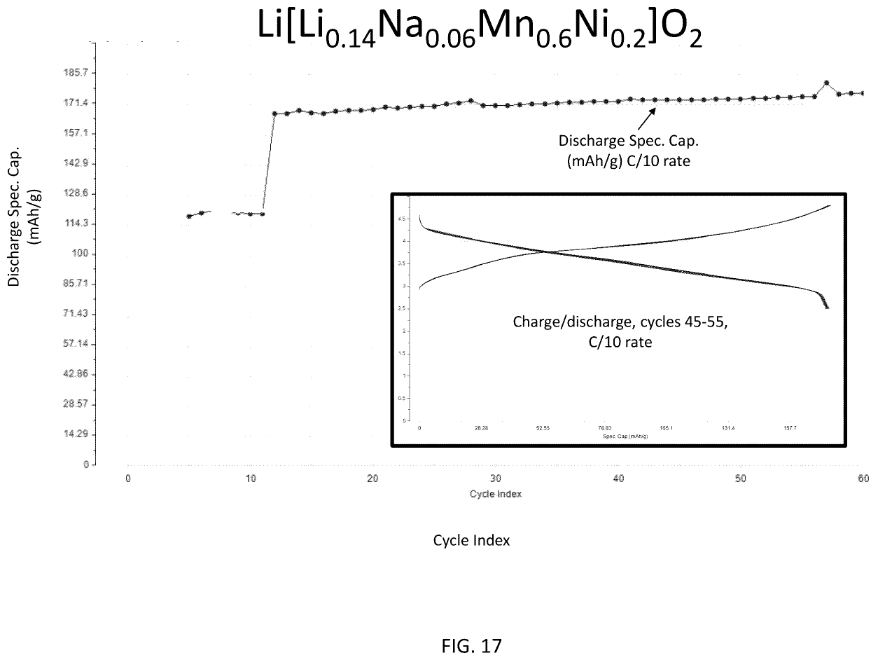

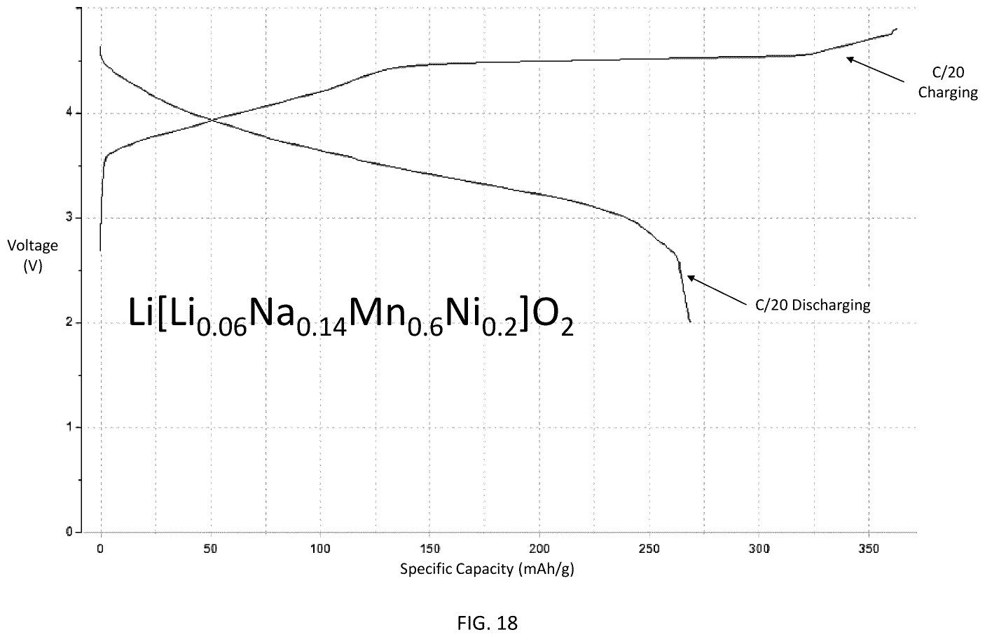

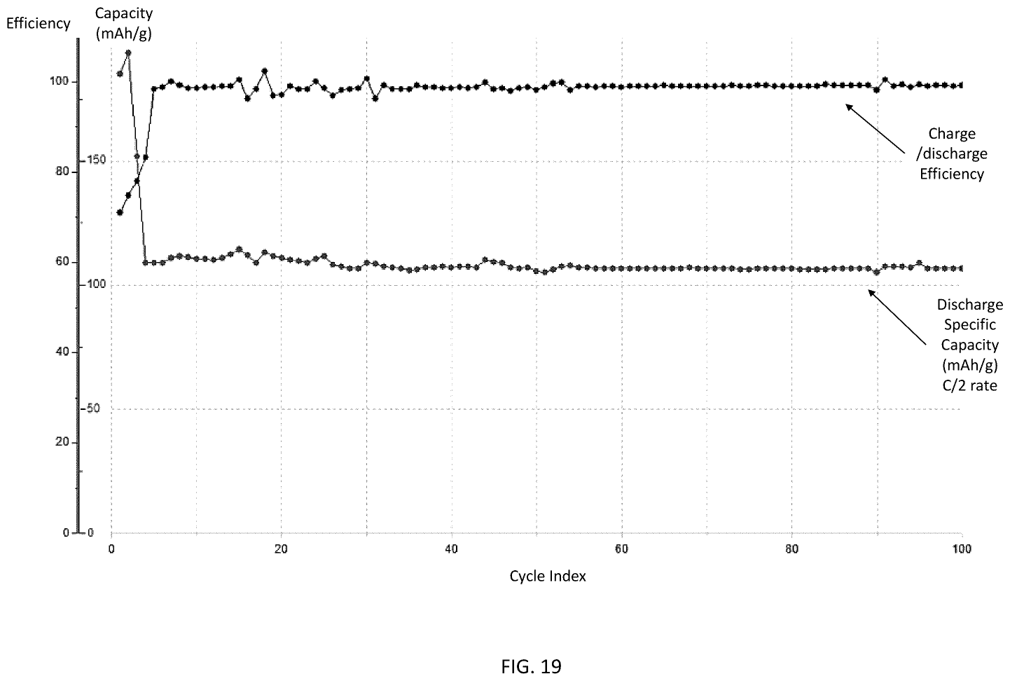

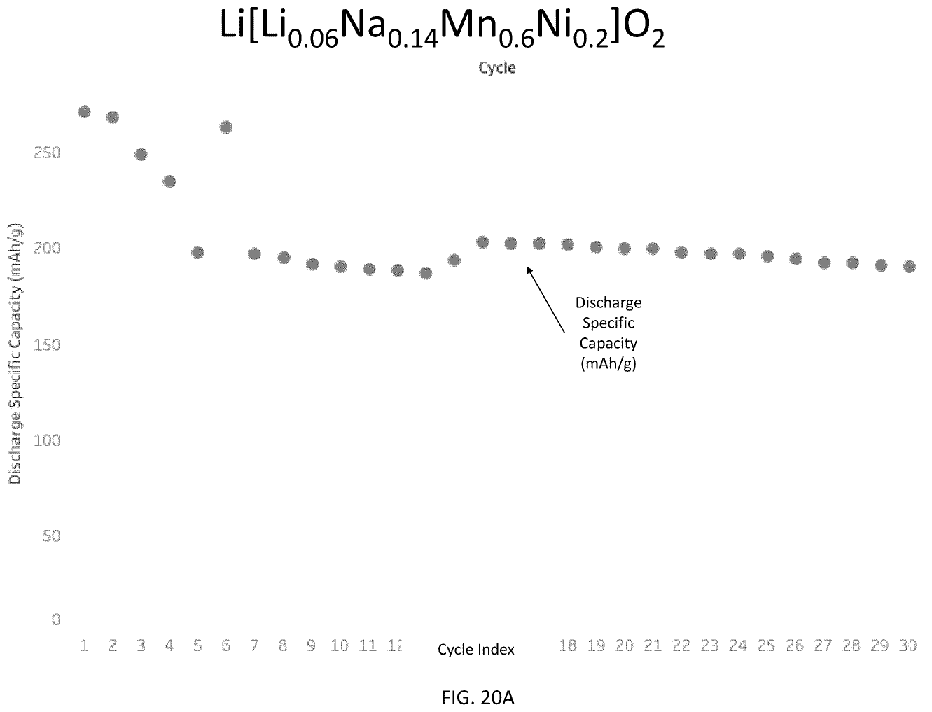

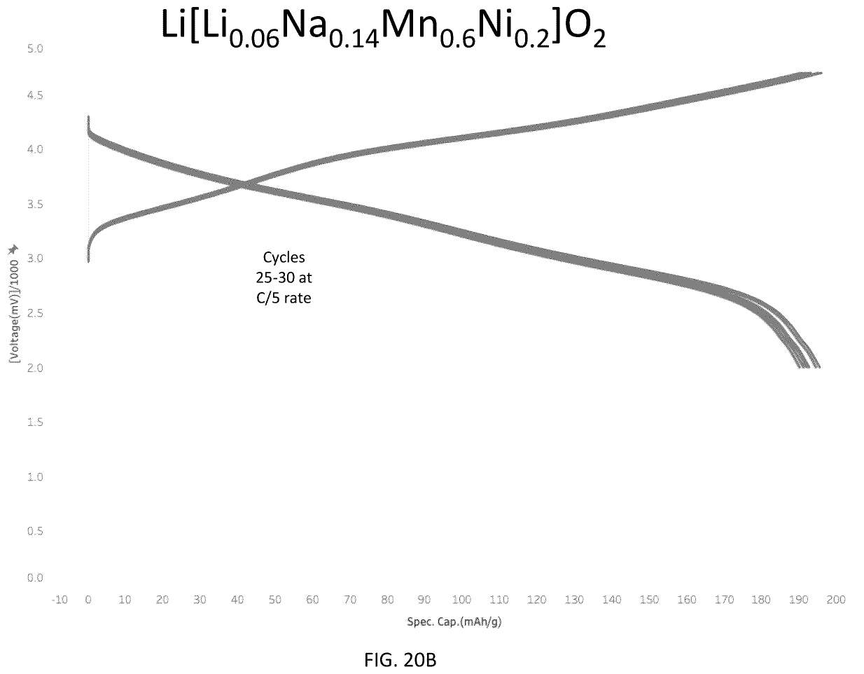

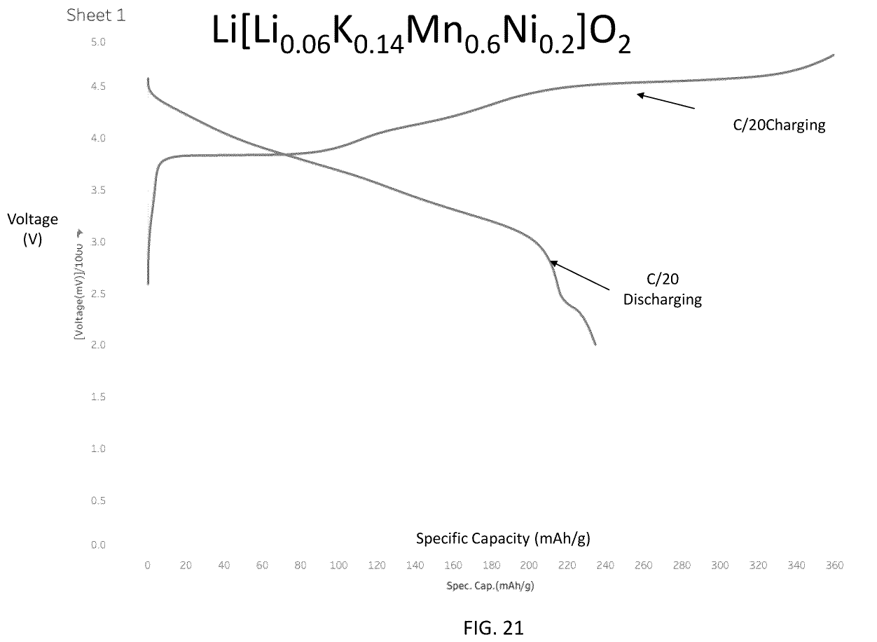

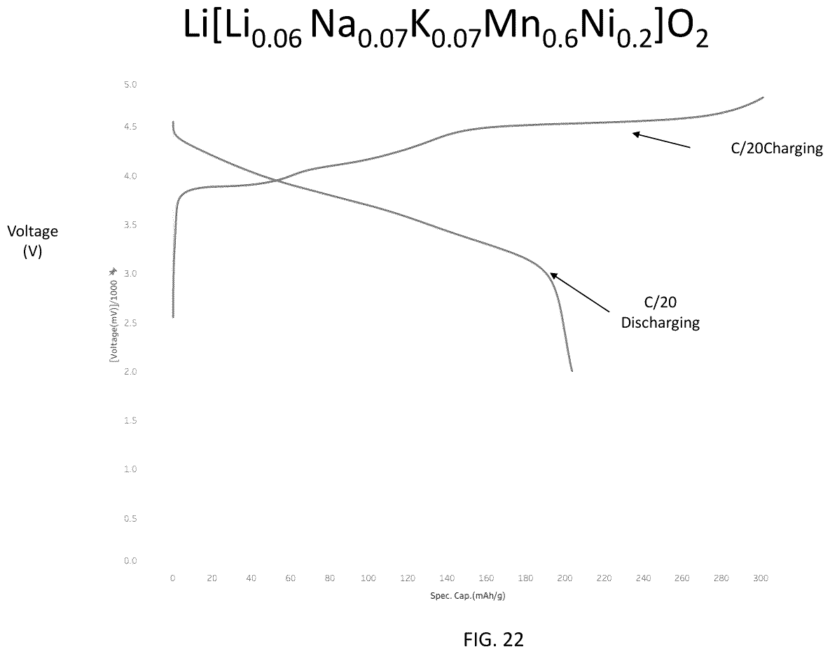

FIGS. 15 to 22 are graphs showing the electrochemical performance of lithium ion cells formed using various identified S-LRMO materials. In particular, FIGS. 15 and 16 are graphs of voltage versus specific capacity for the first two cycles and for cycles 13-26 of the S-LRMO material containing cells, respectively, where the S-LRMO material formula is Li[Li_{0.14} Na_{0.06}Mn_{0.6}Ni_{0.2}]O₂. FIG. 17 is a graph of discharge specific capacity versus cycle number (i.e., cycle stability) and the inset is a graph of voltage versus specific capacity of the S-LRMO material containing cell, where the S-LRMO material formula is Li[Li_{0.14} Na_{0.06}Mn_{0.6}Ni_{0.2}]O₂. FIG. 18 is a plot of charge and discharge specific capacity (i.e., voltage vs. specific capacity) of cells containing the S-LRMO material, where Na is 12.5% substituted for lithium. FIG. 19 is a plot of cycle number versus charge-discharge efficiency and discharge specific capacity for 100 cycles of a cell containing the S-LRMO active material. FIGS. 20A-20B include graphs of discharge specific capacity versus cycle number (i.e., cycle stability) (FIG. 20A) and a graph of voltage versus specific capacity (FIG. 20B), of the S-LRMO material containing cell. The S-LRMO material formula in FIGS. 18-20 is Li[Li_{0.06}Na_{0.14}Mn_{0.6}Ni_{0.2}]O₂. FIGS. 21 and 22 are graphs of voltage versus specific capacity for the first two cycles of the S-LRMO material containing cells, where the S-LRMO material formula is Li[Li_{0.06}K_{0.14} Mn_{0.6}Ni_{0.2}]O₂ and Li[Li_{0.06}Na_{0.07}K_{0.07} Mn_{0.6}Ni_{0.2}]O₂, respectively.

As shown in FIGS. 15-22, the S-LRMO active material had excellent performance and stability, with little to no capacity fade over many cycles, in contrast to the rapid capacity and voltage fade exhibited by conventional Li-rich materials.

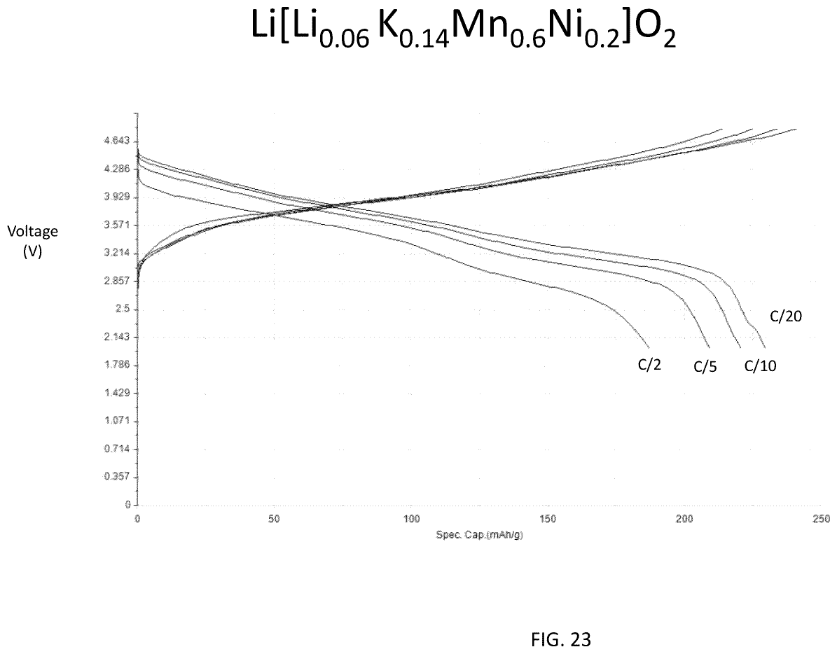

FIG. 23 is a graph of voltage versus specific capacity showing discharge rate data of the Li[Li_{0.06}K_{0.14} Mn_{0.6}Ni_{0.2}]O₂ material. As shown in FIG. 23, the material is highly rate capable and has a capacity of approximately 180 mAh/g at a C/2 rate. This good rate capability may be a result of the alkali atom in the crystalline material creating a more facile lithium ion transport path in the system, thereby enabling better conductivity and rate performance.

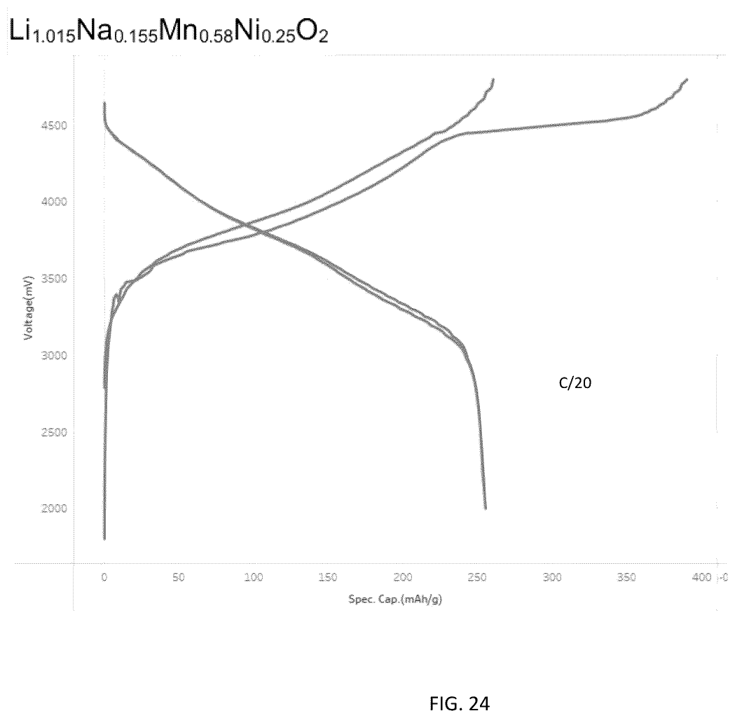

FIG. 24 is a chart showing data for the first two charge/discharge cycles for a lithium metal half-cell made using the material: Li[Li_{0.015} Na_{0.155} Mn_{0.58}Ni_{0.25}]O₂, which shows specific capacity of over 250 mAh/g at C/20 rate.

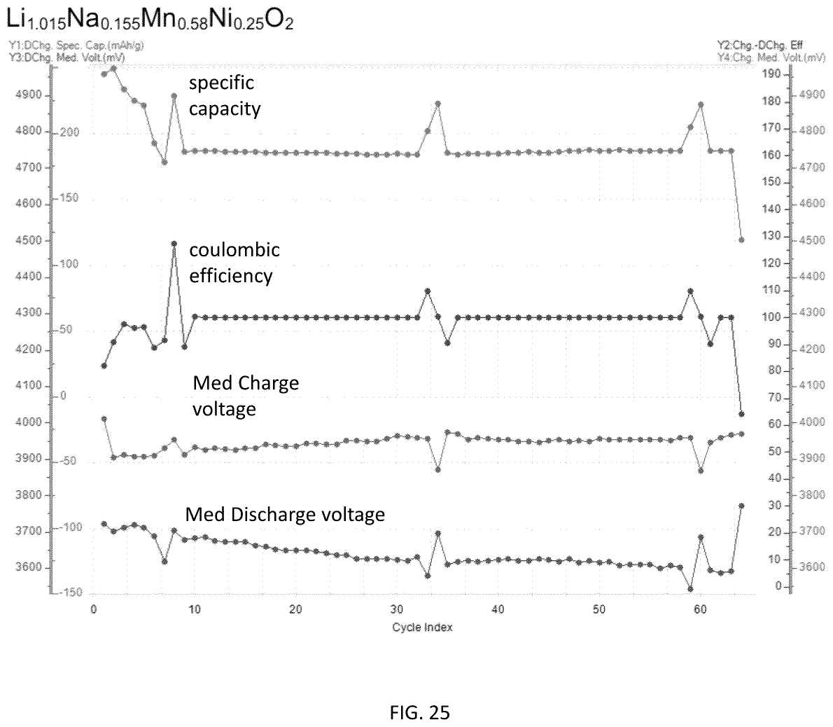

FIG. 25 is a chart showing cycle life data from a lithium metal anode half-cell made of the material: Li[Li_{0.015} Na_{0.155} Mn_{0.58}Ni_{0.25}]O₂, which shows stable capacity retention and repeated reference cycles well over 200 mAh/g. The median discharge voltage is also nominally stable, which is not typical for lithium rich cathode materials.

In particular, the S-LRMO active material exhibited a stable capacity and voltage profile, offering a significant improvement over conventional LRMO materials having similar compositions but that are not substituted or thermally processed (e.g., not rapidly quenched) as described above. Cells including the S-LRMO active material demonstrated a specific capacity of over 260 mAh/g, such as from 265 to 275 mAh/g, at a C/20 rate. As shown in FIG. 16, cells including the Li_{1.14} Na_{0.06}Mn_{0.6}Ni_{0.2}O₂ active material showed stable discharge specific capacity and charge/discharge efficiency over dozens of cycles, thereby demonstrating excellent stability and cycle life. Accordingly, the S-LRMO active material exhibits less than 10% loss (e.g., less than 5% loss, less than 2% loss, or less) in average discharge voltage at a C/20 rate after 200 charge/discharge cycles of a lithium-ion battery, and/or less than 5% capacity fade (e.g., less than 3% capacity fade, less than 2% capacity fade, or less) over 200 C/4 charge/discharge cycles of the lithium-ion battery, and/or over 200 mAh/g specific capacity (e.g., over 230 mAh/g specific capacity, over 250 specific capacity, or greater) when charged and discharged at a C/20 rate, and/or a C/2 discharge specific capacity that is at least 75% (e.g., at least 80%, at least 85%, at least 90%, or more) the C20 discharge specific capacity. In some embodiments, the S-LRMO active material exhibits a fully cycled discharge voltage at a C/20 rate that is greater than or equal to 3.5 V (e.g., greater than or equal to 3.8 V, greater than or equal to 4.0 V, or greater) after 200 cycles. In some embodiments, the S-LRMO active material exhibits a fully cycled discharge voltage at a C/20 rate that is less than or equal to 10.0 V (e.g., less than or equal to 8.0 V, less than or equal to 6.0 V, or less than or equal to 5.0 V) after 200 cycles. Combinations of the above-referenced ranges are also possible (e.g., greater than or equal to 3.5 V and less than or equal to 10.0 V after 200 cycles).

In some embodiments, the S-LRMO active material (e.g., as a cathode active material) exhibits a Li diffusivity value that is at least ⅓ of an order of magnitude (e.g., at least ½ of an order or magnitude or greater, at least 1 order of magnitude or greater, and/or up to 1.5 orders of magnitude, up to 2 orders of magnitude, or more) greater than an otherwise identical non-substituted LRMO at a 30% state of charge or lower (e.g., at a temperature of 298 K). An otherwise identical non-substituted LRMO may have the same stoichiometry as the S-LRMO except that the all species that substituted for lithium in the S-LRMO (e.g., Na, K, Mg, Ca) are replaced with lithium.

In some embodiments, the S-LRMO active material (e.g., as a cathode active material) exhibits a fast-pulse resistance value that is lower (e.g., by at least 20%, at least 30%, at least 40%, at least 50% or lower) than an otherwise identical non-substituted LRMO at a 30% state of charge or lower (e.g., at a temperature of 298 K).

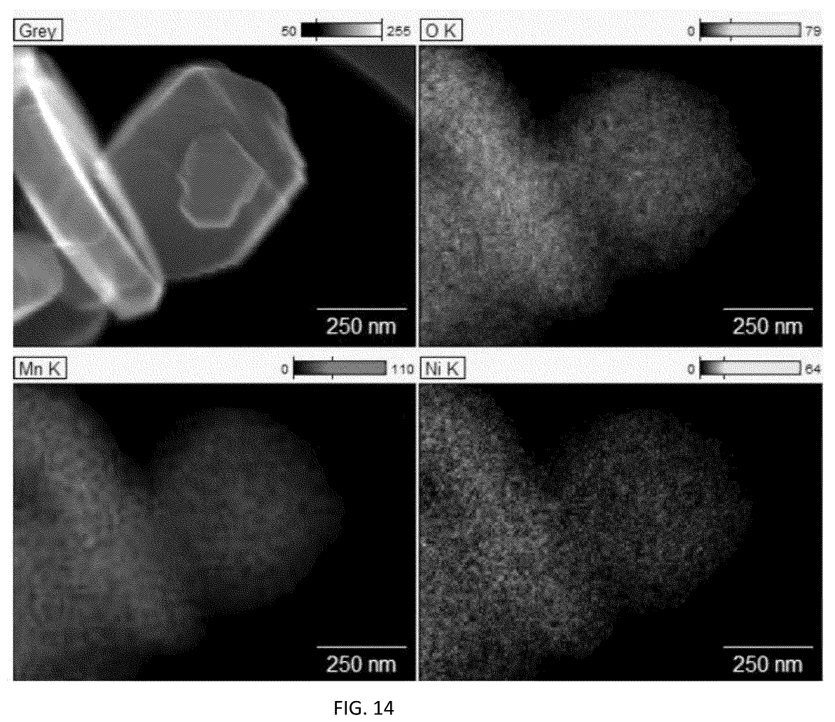

The X-ray data shown in FIGS. 10-13 also shows that high degrees of lithium substitution (e.g., of at least 12.5%) can be accommodated without the crystal structure of the LRMO being substantially affected or the creation of secondary crystalline phases. All of these x-ray diffraction patterns display only the expected lithium-rich crystalline phase structure regardless of type and amount of substitutional material used. The TEM/EDS data shown in FIG. 14 shows that, in this example of a 5% Na substitutional material, there is still an even spatial distribution of Mn and Ni throughout the samples.

### Electrochemical Testing

Synthesized cathode materials were mixed with Super-P carbon black and polyvinylidene fluoride (PVDF) in a ratio of 9.2 to 0.4 to 0.4 making the active material 92% of the overall mass. The resultant blend was then mixed into ˜15 ml of N-Methyl-2-Pyrrolidone for a minimum of one hour before two 10-minute sonication steps, after which the resultant slurry was further allowed to mix on a hot plate at 100° C. for a minimum of 30 minutes before being coated onto 10×10 cm, 50 μm thick aluminum foil heated above 100° C. Foil was allowed to dry in a 70° C. oven in air over night before being punched out with a biopsy punch. These punches were then used to make 2032 coin cells that used lithium foil as the anode, an electrolyte that is a blend of carbonates with a LiPF₆ salt solution as the electrolyte, a Celgard battery separator, 0.5 mm stainless steel spacers, and wave springs on the cathode side to ensure mechanical contact within the cell; each coin cell was assembled and sealed through use of a coin cell press in a dry low-oxygen argon atmosphere.

The electrochemical performance investigations used low-current battery testers to conduct potential limited galvanostatic testing with constant current on the coin cells made in the process described above. The cells were cycled using constant current charge/discharge conditions at rates ranging from C/20 to C/2 between 4.8 and 2 V, as discussed above with respect to FIGS. 15-22.

FIGS. 26A-26B show exemplary galvanostatic intermittent titration data showing that the diffusivity of Li in substituted material is higher at lower states of charge by as much as an order or magnitude. This is of particular interest, in some embodiments, in the rate performance of cathode material at lower voltages is commonly an issue; e.g., in some cases better diffusivity at lower states of charge leads to materials that can support higher power demands when in battery cells that are nearing their end of discharge.

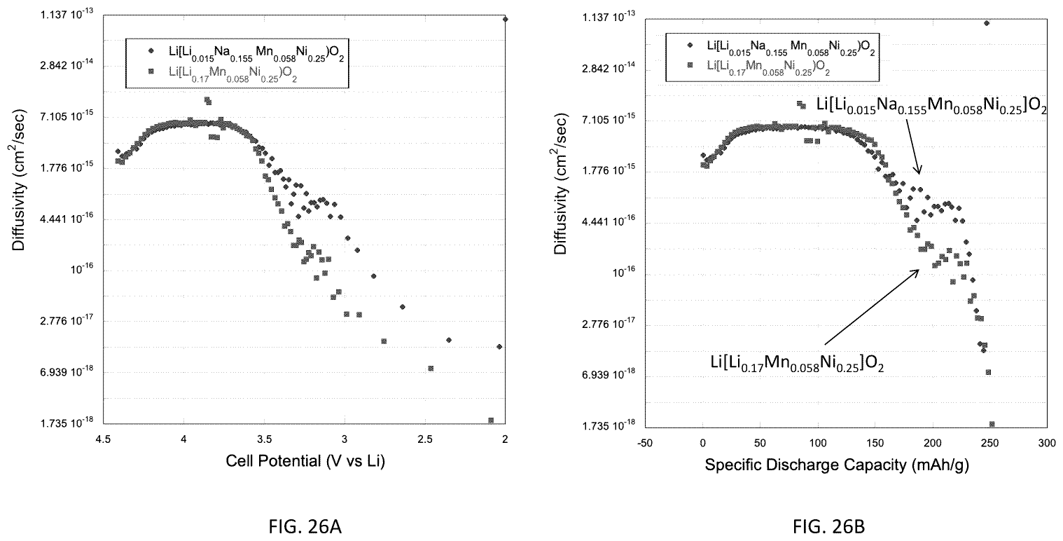

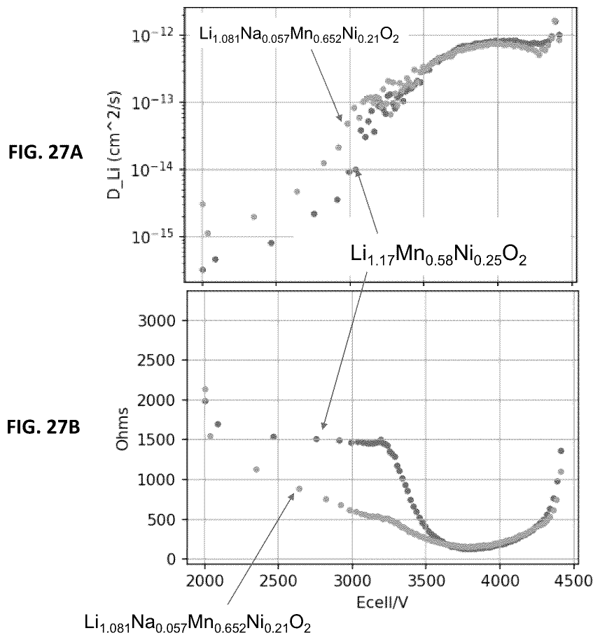

FIGS. 27A and 27B are charts showing GITT (galvanostatic intermittent titration) derived diffusivity data (FIG. 27A) showing that the lithium-ion transport of Li_{1.081}Na_{0.057} Mn_{0.652}Ni_{0.21}O₂ prepared as described is superior in at least some aspects to that of Li_{1.17} Mn_{0.58}Ni_{0.25} O₂ material at lower states of charge, according to one set of embodiments, and fast pulse resistance (FIG. 27B) of identical test cells (14 mm diameter circular electrodes) using Li_{1.081} Na_{0.057} Mn_{0.652}Ni_{0.21}O₂ as compared to Li_{1.17} Mn_{0.58}Ni_{0.25} O₂. The S-LRMO has a diffusivity of about half an order or magnitude higher than non-substituted material below 3.3V. The S-LRMO also has significantly lower fast pulse resistance.

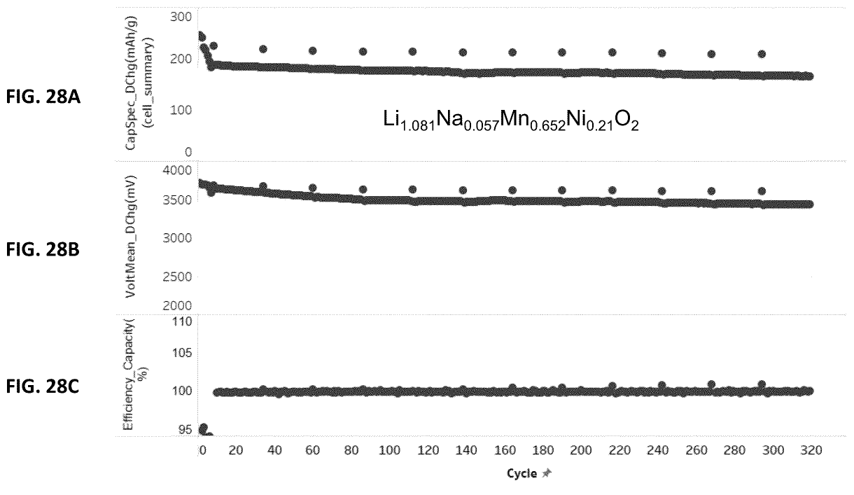

FIGS. 28A-28C are plots showing long term (320 cycles) cycle stability of sodium substituted S-LRMO material (Li_{1.081}Na_{0.057} Mn_{0.652}Ni_{0.21}O₂): FIG. 28A capacity stability (C/3 daily cycles with C/15 reference cycles every 25); FIG. 28B: average discharge voltage; and FIG. 28C coulombic efficiency.

The preceding description of the disclosed aspects is provided to enable any person skilled in the art to make or use the present invention. Various modifications to these aspects will be readily apparent to those skilled in the art, and the generic principles defined herein may be applied to other aspects without departing from the scope of the invention. Thus, the present invention is not intended to be limited to the aspects shown herein but is to be accorded the widest scope consistent with the principles and novel features disclosed herein.

While several embodiments of the present invention have been described and illustrated herein, those of ordinary skill in the art will readily envision a variety of other means and/or structures for performing the functions and/or obtaining the results and/or one or more of the advantages described herein, and each of such variations and/or modifications is deemed to be within the scope of the present invention. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings of the present invention is/are used. Those skilled in the art will recognize, or be able to ascertain using no more than routine experimentation, many equivalents to the specific embodiments of the invention described herein. It is, therefore, to be understood that the foregoing embodiments are presented by way of example only and that, within the scope of the appended claims and equivalents thereto, the invention may be practiced otherwise than as specifically described and claimed. The present invention is directed to each individual feature, system, article, material, and/or method described herein. In addition, any combination of two or more such features, systems, articles, materials, and/or methods, if such features, systems, articles, materials, and/or methods are not mutually inconsistent, is included within the scope of the present invention.

As used herein in the specification and in the claims, the phrase “at least a portion” means some or all. “At least a portion” may mean, in accordance with certain embodiments, at least 1 wt %, at least 2 wt %, at least 5 wt %, at least 10 wt %, at least 25 wt %, at least 50 wt %, at least 75 wt %, at least 90 wt %, at least 95 wt %, or at least 99 wt %, and/or, in certain embodiments, up to 100 wt %.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Other elements may optionally be present other than the elements specifically identified by the “and/or” clause, whether related or unrelated to those elements specifically identified unless clearly indicated to the contrary. Thus, as a non-limiting example, a reference to “A and/or B,” when used in conjunction with open-ended language such as “comprising” can refer, in one embodiment, to A without B (optionally including elements other than B); in another embodiment, to B without A (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

Unless clearly indicated to the contrary, concentrations and percentages described herein are on a mass basis.

As used herein, “wt %” is an abbreviation of weight percentage. As used herein, “at %” is an abbreviation of atomic percentage.

Some embodiments may be embodied as a method, of which various examples have been described. The acts performed as part of the methods may be ordered in any suitable way. Accordingly, embodiments may be constructed in which acts are performed in an order different than illustrated, which may include different (e.g., more or less) acts than those that are described, and/or that may involve performing some acts simultaneously, even though the acts are shown as being performed sequentially in the embodiments specifically described above.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

In the claims, as well as in the specification above, all transitional phrases such as “comprising,” “including,” “carrying,” “having,” “containing,” “involving,” “holding,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

1. A method comprising:
sintering a substituted lithium-rich metal oxide (S-LRMO) material at a sintering temperature to form a sintered S-LRMO material; and
quenching the sintered S-LRMO material from the sintering temperature to a quenching temperature of less than or equal to 120° C. in less than 500 milliseconds to form a quenched S-LRMO active material represented by the formula: 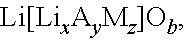
wherein:
A comprises at least one of Na, K, Ca, or Mg,
(x+y) is greater than 0 and less than 0.3,
y>0.05,
z=1−(x+y),
M comprises Mn and Ni, and
b is greater than or equal to 1.8 and less than or equal to 2.2.

2. The method of claim 1, wherein the quenching temperature is greater than or equal to 10° C.

3. The method of claim 1, wherein the quenching temperature is room temperature.

4. The method of claim 1, wherein the sintering temperature is at least 800° C.

5. The method of claim 1, wherein the sintering temperature is greater than or equal to 900° C. and less than or equal to 950° C.

6. The method of claim 1, wherein the quenching the sintered S-LRMO material from the sintering temperature to the quenching temperature comprises quenching the sintered S-LRMO material from the sintering temperature to the quenching temperature in 200 milliseconds or less.

7. The method of claim 1, wherein the quenching the sintered S-LRMO material from the sintering temperature to the quenching temperature comprises quenching the sintered S-LRMO material from the sintering temperature to the quenching temperature in a time period of greater than or equal to 100 milliseconds and less than or equal to 200 milliseconds.

8. The method of claim 1, wherein:
b=2;
an atomic ratio of A to lithium ranges from 0.5:95.5 to 20:80; and
M comprises Mn in an amount of greater than or equal to 50 atomic percent and less than or equal to 80 atomic percent, Ni in an amount of greater than or equal to 20 atomic percent and less than or equal to 50 atomic percent, Ti, Al, Fe, Co, or a combination thereof in an amount of greater than or equal to 0 atomic percent and less than or equal to 10 atomic percent.

9. The method of claim 1, wherein:
the sintering comprises sintering the S-LRMO material in a furnace; and
the quenching comprises quenching the sintered S-LRMO material in a quench bath.

10. The method of claim 1, wherein a time between removing the sintered S-LRMO material from the furnace and quenching the sintered S-LRMO material in the quench bath temperature is 200 milliseconds or less.

11. The method of claim 9, wherein the quench bath comprises a water bath, an oil bath, an alcohol bath or a water bath containing an additive comprising an acid, a carbohydrate, an alcohol, or a combination thereof.

12. The method of claim 1, wherein the quenching comprises quenching the sintered S-LRMO material in a quench bath, wherein the quench bath comprises a water bath, an oil bath, an alcohol bath or a water bath containing an additive comprising an acid, a carbohydrate, an alcohol, or a combination thereof.

13. The method of claim 1, further comprising:
forming a mixture of water and metalloorganic or metal hydroxide precursors of lithium, and one or more transition metals; and
heating the mixture to form a gel;
thermally decomposing the gel to form the S-LRMO material.

14. The method of claim 13, wherein the one or more transition metals comprises nickel and manganese.

15. The method of claim 13, wherein the thermally decomposing the gel comprises using microwave radiation.

16. The method of claim 13, wherein:
the gel comprises a greater than or equal to 0.01 and less than or equal to 0.20 molar fractional excess of the metalloorganic or metal hydroxide precursors of the lithium; and
the S-LRMO material comprises an inorganic material comprising lithium, sodium nickel, manganese, and oxygen.

17. The method of claim 1, wherein the S-LRMO material is represented by a formula selected from the group consisting of: Li_{1.14}Na_{0.06}Mn_{0.6}Ni_{0.2}O₂, Li_{1.06}Na_{0.14}Mn_{0.6}Ni_{0.2}O₂, Li_{1.015}Na_{0.155}Mn_{0.58}Ni_{0.25} O₂, Li_{1.013}Na_{0.157}Mn_{0.52}Ni_{0.32}O₂, and Li_{1.06}K_{0.14}Mn_{0.6}Ni_{0.2}O₂.

18.-21. (canceled)

22. The method of claim 1, further comprising forming a cathode comprising the active S-LRMO material.

23. The method of claim 22, further comprising forming a lithium-ion battery comprising the cathode, an anode, and an electrolyte.

24.-25. (canceled)

26. A method comprising:
thermally decomposing a precursor material using convection heating, microwave radiation, and/or radiative heating to form a thermally decomposed substituted lithium-rich metal oxide (S-LRMO) material;
sintering the thermally decomposed S-LRMO material to form a sintered S-LRMO material; and
quenching the sintered S-LRMO material to form a quenched S-LRMO material represented by a chemical formula: 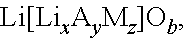
wherein:
A comprises at least one of Na, K, Ca or Mg,
(x+y) is greater than 0 and less than 0.3,
y>0.05,
z=1−(x+y),
M comprises Mn and Ni, and
b is greater than or equal to 1.8 and less than or equal to 2.2.

27.-45. (canceled)

46. A cathode active material represented by a chemical formula: 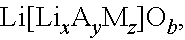
wherein:
A comprises at least one of Na, K, Ca or Mg,
(x+y) is greater than 0 and less than 0.3,
y>0.05,
z=1−(x+y),
M comprises Mn and Ni, and
b is greater than or equal to 1.8 and less than or equal to 2.2.

47. The cathode active material of claim 46, wherein the cathode active material exhibits one or more of:
1) over 200 mAh/g specific capacity when charged and discharged at a C/20 rate;
2) less than 10%, or less than 5%, loss in average discharge voltage at a C/20 rate after 200 charge/discharge cycles in a lithium-ion battery;
3) less than 5% capacity fade over 200 C/4 charge/discharge cycles of the lithium-ion battery;
4) a C/2 discharge specific capacity that is at least 75% the C20 discharge specific capacity; and
5) a fully cycled discharge voltage at a C/20 rate that is greater than or equal to 3.5 V after 200 cycles.

48.-60. (canceled)
